(19) United States
(12) Patent Application Publication
(10) Pub. No.: US 2017/0068380 A1
(43) Pub. Date: Mar. 9, 2017

(54) MOBILE TERMINAL AND METHOD FOR CONTROLLING THE SAME

(71) Applicant: LG ELECTRONICS INC, Seoul (KR)

(72) Inventors: Sungil HONG, Seoul (KR); Jongkyeong PARK, Seoul (KR); Minah SONG, Seoul (KR); Yujin AN, Seoul (KR); Taeho KIM, Seoul (KR); Sangbum CHO, Seoul (KR)

(21) Appl. No.: 15/253,337

(22) Filed: Aug. 31, 2016

(30) Foreign Application Priority Data
Sep. 7, 2015 (KR) 10-2015-0126531

(51) Int. Cl. G06F 3/041

(52) U.S. Cl. CPC G06F 3/0416; G06F 2203/04101

(57) ABSTRACT

A mobile terminal and a method for controlling the same are disclosed. The mobile terminal includes a touch screen and a controller configured to display a first video and a progress bar for controlling a playback of the first video on the touch screen. When the controller receives a drag input of a touch input subsequent to the touch input of the progress bar, the controller is configured to display a screen for inserting a second video subsequent to a time point of the first video corresponding to a time line of the touch input.

### CROSS-REFERENCE TO RELATED APPLICATIONS

Pursuant to 35 U.S.C. §119(a), this application claims the benefit of earlier filing date and right of priority to Korean Patent Application No. 10-2015-0126531, filed on Sep. 7, 2015, the contents of which are incorporated by reference herein in their entirety.

### TECHNICAL FIELD

The present disclosure relates to a mobile terminal and a method for controlling the same, and more particularly to a mobile terminal and a method for controlling the same for more easily editing a video implemented by the mobile terminal.

### DISCUSSION OF THE RELATED ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

### SUMMARY

Accordingly, an object of the present invention is to address the above-noted and other problems.

Another aspect of the present disclosure is to provide a mobile terminal and a method for controlling the same capable of easily editing a video.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

In one aspect, there is provided a mobile terminal comprising a touch screen and a controller configured to display a first video and a progress bar for controlling a playback of the first video on the touch screen, and when receiving a drag input of a touch input subsequent to the touch input of the progress bar, configured to display a screen for inserting a second video subsequent to a time point of the first video corresponding to a time line of the touch input.

The mobile terminal may further comprise a camera configured to produce the second video. The controller may be configured to activate the camera when receiving the drag input and display a preview image of the camera on at least one area of a screen for the playback of the first video.

When the drag input is performed at an angle equal to or greater than a predetermined angle with respect to a travelling direction of the progress bar, the controller may be configured to display the screen for inserting the second video.

When the controller receives the touch input with respect to the progress bar, the controller may be configured to display a preview image of the first video corresponding to the time line of the touch input. When the touch input is dragged in a display direction of the preview image, the controller may be configured to display information for inserting the second video.

The controller may be configured to display a menu for selecting a method for editing the first video and the second video depending on a distance of the drag input.

When it is determined that the distance of the drag input is equal to or greater than a first reference distance and is less than a second reference distance, the controller may be configured to display a menu for selecting a method for editing including inserting or overwriting the second video into or on the first video.

When it is determined that the distance of the drag input is equal to or greater than a second reference distance and is less than a third reference distance, the controller may be configured to display a menu for selecting a frame division method for displaying the first video and the second video on one screen.

When it is determined that the distance of the drag input is equal to or greater than a third reference distance, the controller may be configured to display a menu for selecting a frame division method for displaying a plurality of videos including the first video and the second video on one screen.

The controller may be configured to display the second video on at least one area of the first video. When the controller receives a predetermined input, the controller may be configured to control an aspect ratio of each of the first video and the second video.

The controller may be configured to display the second video on at least one area of the first video. When the controller receives a predetermined input, the controller may be configured to change a display position of the second video displayed on the first video.

The controller may be configured to insert and store the second video subsequent to the time point of the first video corresponding to the time line of the touch input and display the progress bar so that a time line of the progress bar, at which the second video is inserted, is distinguished from a time line of the first video.

The controller may be configured to insert and store the second video subsequent to the time point of the first video corresponding to the time line of the touch input and display a preview image of the second video at a point of the progress bar, at which the second video is inserted.

The controller may be configured to display a preview image of the second video on at least one area of a screen for the playback of the first video. When the controller receives a touch input with respect to the preview image of the second video, the controller may be configured to display the second video on an entire screen of the touch screen.

The controller may be configured to display a menu for selecting an end of the second video on at least one area of the second video. When the menu for selecting the end of the second video is selected, the controller may be configured to insert the second video into the first video and store the second video.

In another aspect, there is provided a method for controlling a mobile terminal comprising displaying a first video and a progress bar for controlling a playback of the first video on a touch screen, receiving a touch input with respect to the progress bar, and when receiving a drag input of the touch input subsequent to the touch input, displaying a screen for inserting a second video subsequent to a time point of the first video corresponding to a time line of the touch input.

The method may further comprise activating a camera configured to produce the second video when receiving the drag input and displaying a preview image of the camera on at least one area of a screen for the playback of the first video.

The displaying of the screen for inserting the second video subsequent to the time point of the first video corresponding to the time line of the touch input when receiving the drag input of the touch input subsequent to the touch input may comprise displaying the screen for inserting the second video when the drag input is performed at an angle equal to or greater than a predetermined angle with respect to a travelling direction of the progress bar.

The method may further comprise when receiving the touch input with respect to the progress bar, displaying a preview image of the first video corresponding to the time line of the touch input, and when dragging the touch input in a display direction of the preview image, displaying information for inserting the second video.

The method may further comprise displaying a menu for selecting a method for editing the first video and the second video depending on a distance of the drag input.

The method may further comprise displaying the second video on at least one area of the first video, and when receiving a predetermined input, controlling an aspect ratio of each of the first video and the second video or changing a display position of the second video.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1a is a block diagram of a mobile terminal according to an embodiment;

FIG. 1b is a front perspective view of the mobile terminal according to an embodiment;

FIG. 1c is a rear perspective view of the mobile terminal according to an embodiment;

FIG. 2 is a flow chart of a method for controlling a mobile terminal according to an embodiment;

FIGS. 3a to 11c illustrate a method for controlling a mobile terminal according to a first embodiment of the invention;

FIGS. 12a to 15c illustrate a method for controlling a mobile terminal according to a second embodiment of the invention;

FIGS. 16a and 16b illustrate a method for controlling a mobile terminal according to a third embodiment of the invention;

FIGS. 17a to 17d illustrate a method for controlling a mobile terminal according to a fourth embodiment of the invention;

FIGS. 18 to 20c illustrate a method for controlling a mobile terminal according to a fifth embodiment of the invention;

FIGS. 21a to 28d illustrate a method for controlling a mobile terminal according to a sixth embodiment of the invention; and

FIGS. 29a to 32b illustrate a method for controlling a mobile terminal according to a seventh embodiment of the invention.

### DETAILED DESCRIPTION

Arrangements and embodiments may now be described more fully with reference to the accompanying drawings, in which exemplary embodiments may be shown. Embodiments may, however, be embodied in many different forms and should not be construed as being limited to embodiments set forth herein; rather, embodiments may be provided so that this disclosure will be thorough and complete, and will fully convey the concept to those skilled in the art.

A mobile terminal may be described below with reference to the accompanying drawings. In the following description, suffixes “module” and “unit” may be given to components of the mobile terminal in consideration of only facilitation of description and do not have meanings or functions discriminated from each other.

The mobile terminal may include a cellular phone, a smart phone, a laptop computer, a digital broadcasting terminal, personal digital assistants (PDA), a portable multimedia player (PMP), a navigation system and/or so on.

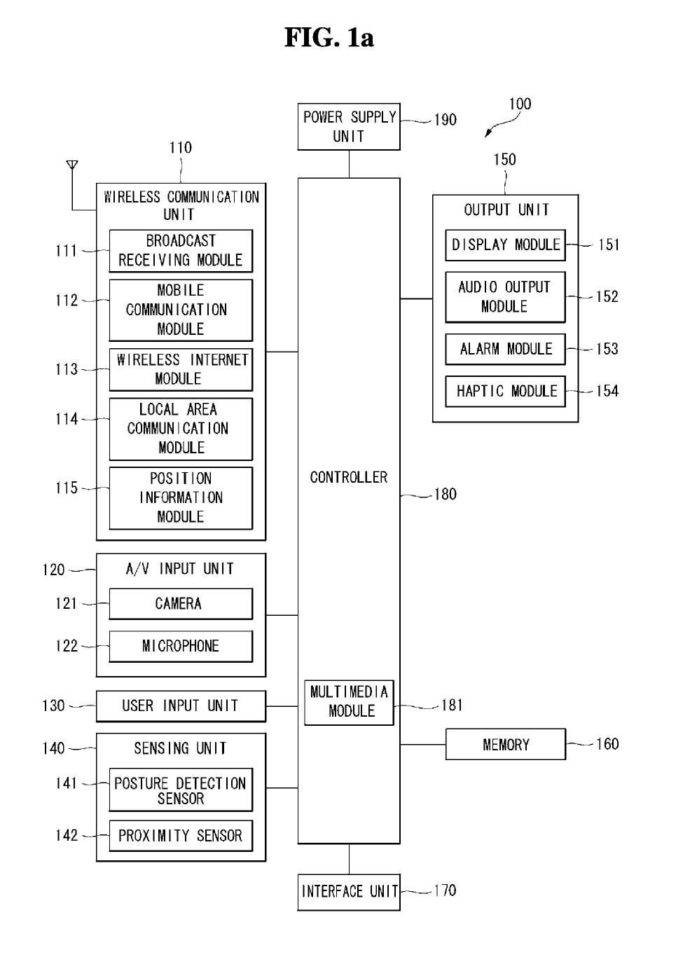

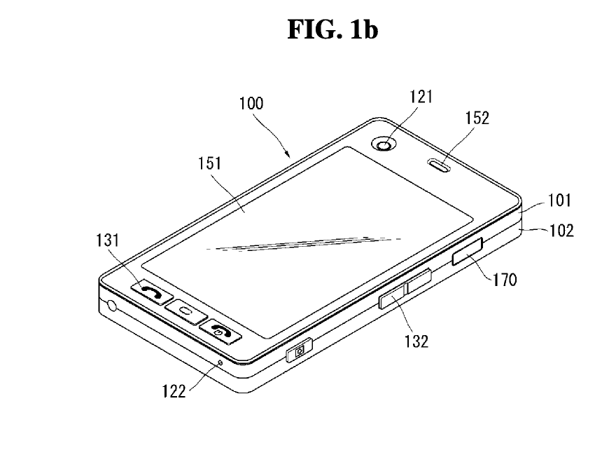

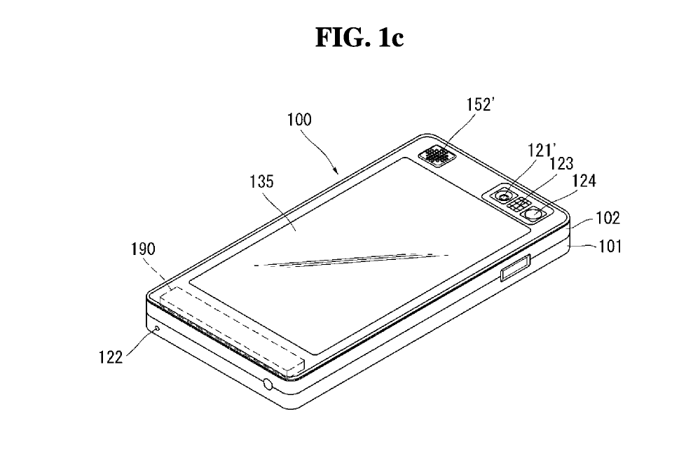

FIG. 1a is a block diagram of a mobile terminal according to an embodiment. Other embodiments, configurations and arrangements may also be provided.

As shown, the mobile terminal 100 may include a wireless communication unit 110 (or radio communication unit), an audio/video (A/V) input unit 120, a user input unit 130, a sensing unit 140, an output unit 150, a memory 160, an interface 170, a controller 180, and a power supply unit 190. The components shown in FIG. 1a may be essential parts and/or a number of components included in the mobile terminal 100 may vary. Components of the mobile terminal 100 may now be described.

The wireless communication unit 110 may include at least one module that enables radio communication between the mobile terminal 100 and a radio communication system or between the mobile terminal 100 and a network in which the mobile terminal 100 is located. For example, the wireless communication unit 110 may include a broadcasting receiving module 111, a mobile communication module 112, a wireless Internet module 113, a short range communication module 114 (or local area communication module), and a location information module 115 (or position information module).

The broadcasting receiving module 111 may receive broadcasting signals and/or broadcasting related information from an external broadcasting management server through a broadcasting channel. The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal.

The broadcasting signals may include not only TV broadcasting signals, radio broadcasting signals, and data broadcasting signals but also signals in the form of a combination of a TV broadcasting signal and a radio broadcasting signal. The broadcasting related information may be information on a broadcasting channel, a broadcasting program or a broadcasting service provider, and may be provided even through a mobile communication network. In the latter case, the broadcasting related information may be received by the mobile communication module 112.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. More particularly, the broadcasting receiving module 111 may receive digital broadcasting signals using digital broadcasting systems such as a digital multimedia broadcasting-terrestrial (DMB-T) system, a digital multimedia broadcasting-satellite (DMB-S) system, a media forward link only (MediaFLO) system, a DVB-H and integrated services digital broadcast-terrestrial (ISDB-T) systems. The broadcasting receiving module 111 may receive signals from broadcasting systems providing broadcasting signals other than the above-described digital broadcasting systems.

The broadcasting signals and/or broadcasting related information received through the broadcasting receiving module 111 may be stored in the memory 160. The mobile communication module 112 may transmit/receive a radio signal to/from at least one of a base station, an external terminal and a server on a mobile communication network. The radio signal may include a voice call signal, a video telephony call signal or data in various forms according to transmission and reception of text/multimedia messages.

The wireless Internet module 113 may correspond to a module for wireless Internet access and may be included in the mobile terminal 100 or may be externally attached to the mobile terminal 100. Wireless LAN (WLAN or Wi-Fi), wireless broadband (Wibro), world interoperability for microwave access (Wimax), high speed downlink packet access (HSDPA) and so on may be used as a wireless Internet technique.

The short range communication module 114 may correspond to a module for short range communication. Further, Bluetooth®, radio frequency identification (RFID), infrared data association (IrDA), ultra wideband (UWB) and/or ZigBee® may be used as a short range communication technique.

The location information module 115 may confirm or obtain a location or a position of the mobile terminal 100. The location information module 115 may obtain position information by using a global navigation satellite system (GNSS). The GNSS is a terminology describing a radio navigation satellite system that revolves around the earth and transmits reference signals to predetermined types of radio navigation receivers such that the radio navigation receivers can determine their positions on the earth's surface or near the earth's surface. The GNSS may include a global positioning system (GPS) of the United States, Galileo of Europe, a global orbiting navigational satellite system (GLONASS) of Russia, COMPASS of China, and a quasi-zenith satellite system (QZSS) of Japan, for example.

A global positioning system (GPS) module is a representative example of the location information module 115. The GPS module may calculate information on distances between one point or object and at least three satellites and information on a time when distance information is measured and apply trigonometry to the obtained distance information to obtain three-dimensional position information on the point or object according to latitude, longitude and altitude at a predetermined time.

A method of calculating position and time information using three satellites and correcting the calculated position and time information using another satellite may also be used. Additionally, the GPS module may continuously calculate a current position in real time and calculate velocity information using the location or position information.

The A/V input unit 120 may input (or receive) an audio signal and/or a video signal. The A/V input unit 120 may include a camera 121 and a microphone 122. The camera 121 may process image frames of still images or moving images obtained by an image sensor in a video telephony mode or a photographing mode. The processed image frames may be displayed on a display module 151, which may be a touch screen.

The image frames processed by the camera 121 may be stored in the memory 160 or may be transmitted to an external device through the wireless communication unit 110. The mobile terminal 100 may also include at least two cameras 121.

The microphone 122 may receive an external audio signal in a call mode, a recording mode and/or a speech recognition mode, and the microphone 122 may process the received audio signal into electric audio data. The audio data may then be converted into a form that can be transmitted to a mobile communication base station through the mobile communication module 112 and output in the call mode. The microphone 122 may employ various noise removal algorithms (or noise canceling algorithm) for removing or reducing noise generated when the external audio signal is received.

The user input unit 130 may receive input data for controlling operation of the mobile terminal 100 from a user. The user input unit 130 may include a keypad, a dome switch, a touch pad (constant voltage/capacitance), a jog wheel, a jog switch and/or so on.

The sensing unit 140 may sense a current state of the mobile terminal 100, such as an open/close state of the mobile terminal 100, a position of the mobile terminal 100, whether a user touches the mobile terminal 100, a direction of the mobile terminal 100, and acceleration/deceleration of the mobile terminal 100, and the sensing unit 140 may generate a sensing signal for controlling operation of the mobile terminal 100. For example, in an example of a slide phone, the sensing unit 140 may sense whether the slide phone is opened or closed. Further, the sensing unit 140 may sense whether the power supply unit 190 supplies power and/or whether the interface 170 is connected to an external device. The sensing unit 140 may also include a proximity sensor. The sensing unit 140 may sense a motion of the mobile terminal 100.

The output unit 150 may generate visual, auditory and/or tactile output, and the output unit 150 may include the display module 151, an audio output module 152, an alarm 153 and a haptic module 154. The display module 151 may display information processed by the mobile terminal 100. The display module 151 may display a user interface (UI) and/or a graphic user interface (GUI) related to a telephone call when the mobile terminal 100 is in the call mode. The display module 151 may also display a captured and/or received image, a UI or a GUI when the mobile terminal 100 is in the video telephony mode or the photographing mode.

The display module 151 may include at least one of a liquid crystal display, a thin film transistor liquid crystal display, an organic light-emitting diode display, a flexible display and/or a three-dimensional display. The display module 151 may be of a transparent type or a light transmissive type. That is, the display module 151 may include a transparent display.

The transparent display may be a transparent liquid crystal display. A rear structure of the display module 151 may also be of a light transmissive type. Accordingly, a user may see an object located behind the body (of the mobile terminal 100) through the transparent area of the body of the mobile terminal 100 that is occupied by the display module 151.

The mobile terminal 100 may also include at least two displays 151. For example, the mobile terminal 100 may include a plurality of displays 151 that are arranged on a single face at a predetermined distance or integrated displays. The plurality of displays 151 may also be arranged on different sides.

When the display module 151 and a sensor sensing touch (hereafter referred to as a touch sensor) form a layered structure that is referred to as a touch screen, the display module 151 may be used as an input device in addition to an output device. The touch sensor may be in the form of a touch film, a touch sheet, and/or a touch pad, for example.

The touch sensor may convert a variation in pressure applied to a specific portion of the display module 151 or a variation in capacitance generated at a specific portion of the display module 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 may detect a touched portion of the display module 151.

The proximity sensor (of the sensing unit 140) may be located in an internal region of the mobile terminal 100, surrounded by the touch screen, and/or near the touch screen. The proximity sensor may sense an object approaching a predetermined sensing face or an object located near the proximity sensor using an electromagnetic force or infrared rays without having mechanical contact. The proximity sensor may have a lifetime longer than a contact sensor and may thus have a wide application in the mobile terminal 100.

The proximity sensor may include a transmission type photo-electric sensor, a direct reflection type photo-electric sensor, a mirror reflection type photo-electric sensor, a high-frequency oscillating proximity sensor, a capacitive proximity sensor, a magnetic proximity sensor, and/or an infrared proximity sensor. A capacitive touch screen may be constructed such that proximity of a pointer is detected through a variation in an electric field according to the proximity of the pointer. The touch screen (touch sensor) may be classified as a proximity sensor.

For ease of explanation, an action of the pointer approaching the touch screen without actually touching the touch screen may be referred to as a proximity touch and an action of bringing the pointer into contact with the touch screen may be referred to as a contact touch. The proximity touch point of the pointer on the touch screen may correspond to a point of the touch screen at which the pointer is perpendicular to the touch screen.

The proximity sensor may sense the proximity touch and a proximity touch pattern (e.g., a proximity touch distance, a proximity touch direction, a proximity touch velocity, a proximity touch time, a proximity touch position, a proximity touch moving state, etc.). Information corresponding to the sensed proximity touch action and proximity touch pattern may then be displayed on the touch screen.

The audio output module 152 may output audio data received from the wireless communication unit 110 or stored in the memory 160 in a call signal receiving mode, a telephone call mode or a recording mode, a speech recognition mode and a broadcasting receiving mode. The audio output module 152 may output audio signals related to functions, such as a call signal incoming tone and a message incoming tone, performed in the mobile terminal 100. The audio output module 152 may include a receiver, a speaker, a buzzer, and/or the like. The audio output module 152 may output sounds through an earphone jack. The user may hear the sounds by connecting an earphone to the earphone jack.

The alarm 153 may output a signal for indicating generation of an event of the mobile terminal 100. For example, an alarm may be generated when receiving a call signal, receiving a message, inputting a key signal, and/or inputting a touch. The alarm 153 may also output signals in forms different from video signals or audio signals, for example, a signal for indicating generation of an event through vibration. The video signals and/or the audio signals may also be output through the display module 151 or the audio output module 152.

The haptic module 154 may generate various haptic effects that the user can feel. One example of the haptic effects is vibration. An intensity and/or pattern of vibration generated by the haptic module 154 may also be controlled. For example, different vibrations may be combined and output or may be sequentially output.

The haptic module 154 may generate a variety of haptic effects including an effect of stimulus according to an arrangement of pins vertically moving against a contact skin surface, an effect of stimulus according to a jet force or sucking force of air through a jet hole or a sucking hole, an effect of stimulus of rubbing the skin, an effect of stimulus according to contact of an electrode, an effect of stimulus using an electrostatic force, and an effect according to a reproduction of cold and warmth using an element capable of absorbing or radiating heat in addition to vibrations.

The haptic module 154 may not only transmit haptic effects through direct contact but may also allow the user to feel haptic effects through a kinesthetic sense of the user's fingers or arms. The mobile terminal 100 may also include a plurality of haptic modules 154.

The memory 160 may store a program for operations of the controller 180 and/or temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk and/or an optical disk. The mobile terminal 100 may also operate in relation to a web storage that performs a storing function of the memory 160 on the Internet.

The interface 170 may serve as a path to external devices connected to the mobile terminal 100. The interface 170 may receive data from the external devices or power and transmit the data or power to internal components of the mobile terminal 100 or transmit data of the mobile terminal 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The interface 170 may also interface with a user identification module that is a chip that stores information for authenticating authority to use the mobile terminal 100. For example, the user identification module may be a user identify module (UIM), a subscriber identify module (SIM) and/or a universal subscriber identify module (USIM). An identification device (including the user identification module) may also be manufactured in the form of a smart card. Accordingly, the identification device may be connected to the mobile terminal 100 through a port of the interface 170.

The interface 170 may also be a path through which power from an external cradle is provided to the mobile terminal 100 when the mobile terminal 100 is connected to the external cradle or a path through which various command signals input by the user through the cradle are transmitted to the mobile terminal 100. The various command signals or power input from the cradle may be used as signals for confirming whether the mobile terminal 100 is correctly set in the cradle.

The controller 180 may control overall operations of the mobile terminal 100. For example, the controller 180 may perform control and processing for voice communication, data communication and/or video telephony. The controller 180 may also include a multimedia module 181 for playing multimedia. The multimedia module 181 may be included in the controller 180 or may be separated from the controller 180.

The controller 180 may perform a pattern recognition process capable of recognizing handwriting input or picture-drawing input applied to the touch screen as characters or images. The power supply unit 190 may receive external power and internal power and provide power required for operations of the components of the mobile terminal 100 under control of the controller 180.

According to hardware implementation, embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. Embodiments may be implemented by the controller 180.

According to software implementation, embodiments such as procedures or functions may be implemented with a separate software module that executes at least one function or operation. Software codes may be implemented according to a software application written in an appropriate software language. The software codes may be stored in the memory 160 and executed by the controller 180.

FIG. 1b is a front perspective view of a mobile terminal (or a handheld terminal) according to an embodiment.

The mobile terminal 100 may be a bar type terminal body. However, embodiments are not limited to a bar type terminal and may be applied to terminals of various types including slide type, folder type, swing type and/or swivel type terminals having at least two bodies that are relatively movably combined.

The terminal body may include a case (a casing, a housing, a cover, etc.) that forms an exterior of the mobile terminal 100. In this embodiment, the case may be divided into a front case 101 and a rear case 102. Various electronic components may be arranged in the space formed between the front case 101 and the rear case 102. At least one middle case may be additionally provided between the front case 101 and the rear case 102.

The cases may be formed of plastics through injection molding or made of a metal material such as stainless steel (STS) or titanium (Ti).

The display module 151, the audio output unit 152, the camera 121, the user input unit 130/131 and 132, the microphone 122 and the interface 170 may be arranged (or provided) in the terminal body, and more specifically may be arranged (or provided) in the front case 101.

The display module 151 may occupy most of the main face of the front case 101. The audio output unit 152 and the camera 121 may be arranged in a region in proximity to one of both ends of the display module 151 and the user input unit 131, and the microphone 122 may be located in a region in proximity to another end of the display module 151. The user input unit 132 and the interface 170 may be arranged (or provided) on sides of the front case 101 and the rear case 102.

The user input unit 130 may receive commands for controlling operation of the mobile terminal 100, and may include a plurality of operating units 131 and 132. The operating units 131 and 132 may be referred to as manipulating portions and may employ any tactile manner in which a user operates the operating units 131 and 132 while having tactile feeling.

The first and second operating units 131 and 132 may receive various inputs. For example, the first operating unit 131 may receive commands such as start, end and scroll and the second operating unit 132 may receive commands such as control of a volume of sound output from the audio output unit 152 or conversion of the display module 151 to a touch recognition mode.

FIG. 1c is a rear perspective view of the mobile terminal (shown in FIG. 1b) according to an embodiment.

Referring to FIG. 1b, a camera 121′ may be additionally attached to the rear side of the terminal body (i.e., the rear case 102). The camera 121′ may have a photographing direction opposite to that of the camera 121 (shown in FIG. 1b) and may have pixels different from those of the camera 121 (shown in FIG. 1b).

For example, it may be desirable that the camera 121 has low pixels such that the camera 121 may capture an image of a face of a user and transmit the image to a receiving part in case of video telephony while the camera 121′ has high pixels because the camera 121′ captures an image of a general object and does not immediately transmit the image in many cases. The cameras 121 and 121′ may be attached (or provided) to the terminal body such that the cameras 121 and 121′ may rotate or pop-up.

A flash bulb 123 and a mirror 124 may be additionally provided in proximity to the camera 121′. The flash bulb 123 may light an object when the camera 121′ takes a picture of the object. The mirror 124 may be used for the user to look at his/her face in the mirror when the user wants to self-photograph himself/herself using the camera 121′.

An audio output unit 152′ may be additionally provided on the rear side of the terminal body. The audio output unit 152′ may achieve a stereo function with the audio output unit 152 (shown in FIG. 1b) and may be used for a speaker phone mode when the terminal is used for a telephone call.

A broadcasting signal receiving antenna may be additionally attached (or provided) to the side of the terminal body in addition to an antenna for telephone calls. The antenna constructing a part of the broadcasting receiving module 111 (shown in FIG. 1a) may be set in the terminal body such that the antenna may be pulled out of the terminal body.

The power supply unit 190 for providing power to the mobile terminal 100 may be set in the terminal body. The power supply unit 190 may be included in the terminal body or may be detachably attached to the terminal body.

A touch pad 135 for sensing touch may be attached to the rear case 102. The touch pad 135 may be of a light transmission type, such as the display module 151. In this example, if the display module 151 outputs visual information through both sides thereof, the visual information may be recognized (or determined) by the touch pad 135. The information output through both sides of the display module 151 may be controlled by the touch pad 135. Otherwise, a display may be additionally attached (or provided) to the touch pad 135 such that a touch screen may be arranged (or provided) even in the rear case 102.

The touch pad 135 may operate in connection with the display module 151 of the front case 101. The touch pad 135 may be located in parallel with the display module 151 behind the display module 151. The touch panel 135 may be identical to or smaller than the display module 151 in size.

Hereinafter, embodiments related to a control method capable of being implemented by the mobile terminal thus configured are described with reference to the accompanying drawings. The embodiments may be embodied in many different forms and should not be construed as being limited to embodiments set forth herein.

In the embodiment disclosed herein, the display unit 151 is regarded as a touch screen 151 in consideration of only facilitation of description. As described above, the touch screen 151 may perform both an information display function and an information input function. However, embodiments of the invention are not limited thereto. Further, a touch referred to embodiments of the invention may include all of a contact touch and a proximity touch.

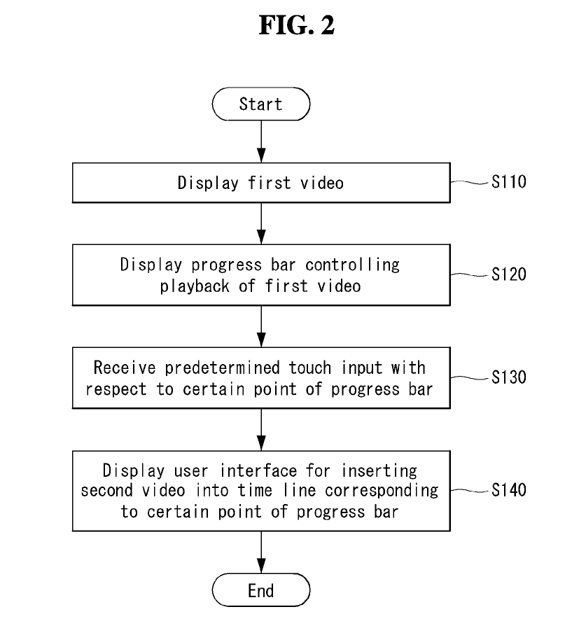

FIG. 2 is a flow chart of a method for controlling a mobile terminal according to an embodiment. The mobile terminal according to the embodiment includes a touch screen 151 and a controller 180 configured to control an image display and letter function based on an input with respect to the touch screen 151.

Referring to FIG. 2, the controller 180 may be configure to display a first video on the touch screen 151 in S110. The controller 180 may be configured to execute a video playback application and reproduce video data stored in the mobile terminal to display the first video. Alternatively, the controller 180 may be configured to reproduce video data received through a network, for example, Internet, or receive a broadcasting signal to display the first video.

The controller 180 may be configure to display a progress bar controlling playback of the first video along with the first video in S120. The progress bar may display information related to a playback time of a video. The progress bar may display a total playback time and a current playback position of the video. The progress bar may include a playing head or a handler button indicating the current playback position. The progress bar may have a bar-shaped appearance indicating a playback period from a playback start time point to a playback end time point of the first video. Other appearances may be used for the progress bar. For example, a playback of contents may be controlled through a control item having a shape of a jog shuttle capable of controlling a playback period of the contents. In the following description, embodiments of the invention are described using the bar-shaped progress bar as an example of a graphical user interface (GUI) for controlling the playback of the video.

The controller 180 may be configure to receive a predetermined touch input with respect to a certain point of the progress bar in S130. The predetermined touch input may include a drag input subsequent to the touch input with respect to the certain point of the progress bar. In the embodiment disclosed herein, the controller 180 may be configured to process the drag input as other input depending on a displacement of the drag input based on changes in the displacement of the drag input starting at the progress bar in a specific direction.

When an input direction of the drag input subsequent to the touch input with respect to the certain point of the progress bar satisfies a predetermined angle and the change in the displacement of the drag input satisfies a predetermined reference, the controller 180 may be configure to display a user interface for inserting a second video into a time line corresponding to a selected point of the progress bar in S140.

In this instance, when the drag input is performed at an angle close to a right angle with respect to a travelling direction of the progress bar, the controller 180 may be configured to display a screen for inserting the second video.

When a touch input of the progress bar is received, the controller 180 may be configure to display a preview image of the first video corresponding to a time line of the touch input. When the touch input is dragged in a display direction of the preview image of the first video, the controller 180 may be configure to display information for inserting the second video.

The controller 180 may be configure to display a menu for selecting a method (for example, overwriting, insertion, frame dividing method, PIP applying method, etc.) for inserting the second video into the first video depending on a distance of the drag input.

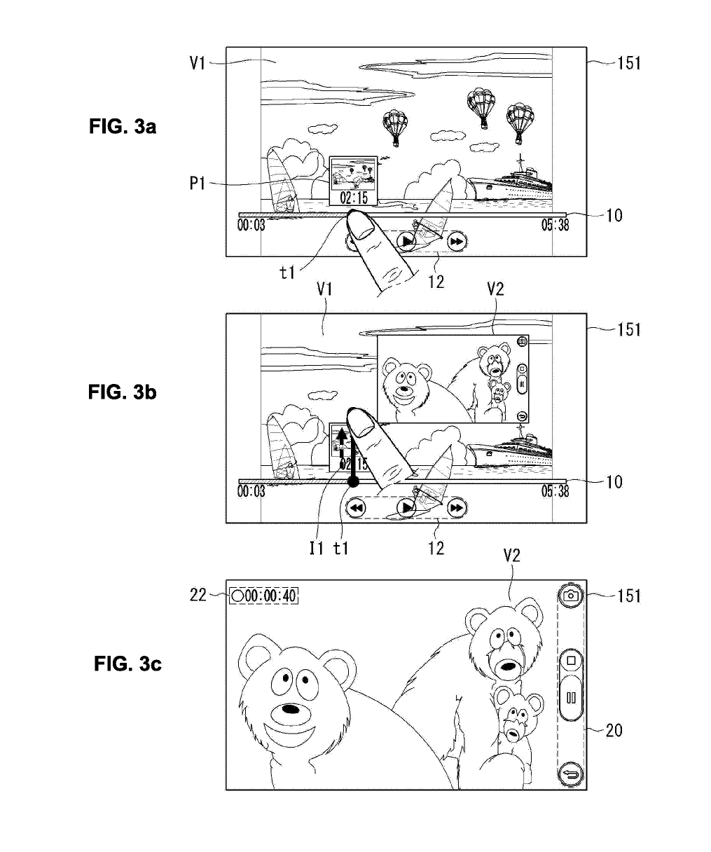

FIGS. 3 to 11 illustrate a method for controlling a mobile terminal according to a first embodiment of the invention. More specifically, FIGS. 3 to 11 illustrate an example of displaying a screen for inserting a video taken with a camera as a second video when an input with respect to a progress bar controlling playback of a first video is received.

Referring to (a) of FIG. 3, the controller 180 may be configured to display a first video V1 on the touch screen 151 and display a progress bar 10 and a playback control menu 12 for controlling playback of the first video V1 on the touch screen 151. The progress bar 10 may display a total playback time and a current playback position of the video. The progress bar 10 may include a playing head or a handler button indicating the current playback position.

When the controller 180 receives a touch input with respect to a certain point t1 of the progress bar 10, the controller 180 may be configured to display a frame of the first video V1 of a time point corresponding to a touch point as a frame screen P1.

Referring to (b) of FIG. 3, when it is determined that a drag input I1 subsequent to the touch input with respect to the certain point t1 of the progress bar 10 drags the frame of the first video to the frame screen P1, the controller 180 may be configured to display a screen for inserting a second video V2. When the controller 180 receives the drag input I1 subsequent to the touch input with respect to the certain point t1, the controller 180 may be configured to activate the camera 121 and provide a preview image of the camera 121 as the second video V2 in a predetermined area of the first video V1.

Referring to (c) of FIG. 3, when it is determined that a user touch performing the drag input I1 is released, the controller 180 may be configured to display the preview image (i.e., the second video V2) of the camera 121 on the entire screen of the touch screen 151 and start a recording of the second video V2. Hence, the touch screen 151 may display the second video V2 being recorded, a camera control menu 20, and a recording state notification 22.

The controller 180 may be configured to record the second video V2 taken with the camera 121 subsequent to the certain point t1 of the first video V1 selected from the progress bar 10. In this instance, the controller 180 may be configured to insert the second video V2 taken with the camera 121 into the certain point t1 of the first video V1 or overwrite the second video V2 taken with the camera 121 on the certain point t1 of the first video V1.

The above embodiment described an example where the recording of the second video V2 automatically starts when the user touch performing the drag input I1 is released. However, a menu related to the recording capable of selecting a start time point and a stop time point of the recording may be provided.

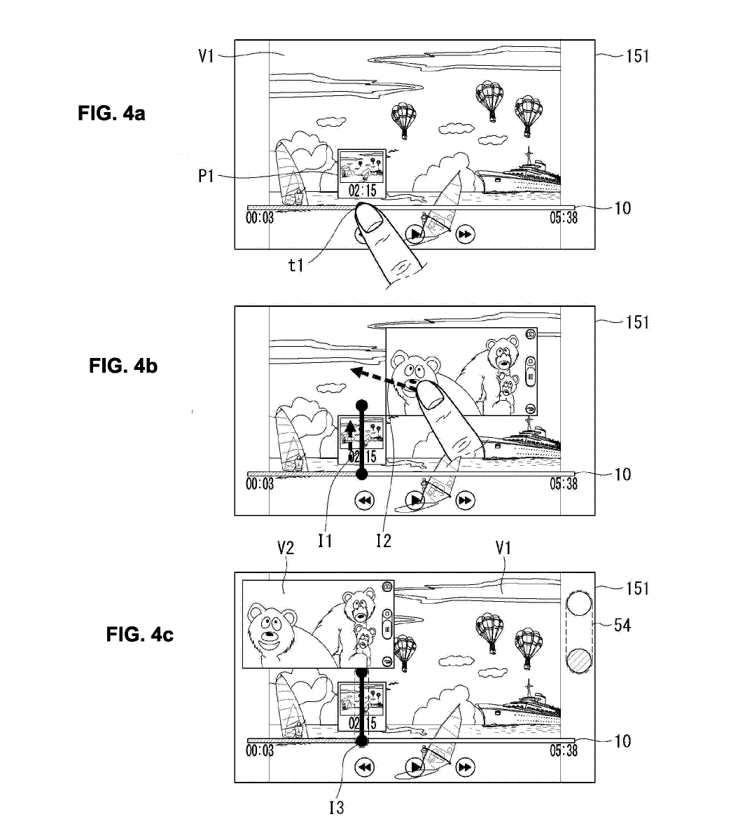

FIG. 4 illustrates an example of receiving a second drag input 12 subsequent to a first drag input I1 and adjusting a position of a second video V2 after the user touches the progress bar 10 and performs the first drag input I1 as shown in FIG. 3.

Referring to (a) of FIG. 4, the controller 180 may be configured to display a first video V1 on the touch screen 151 and display the progress bar 10 and the playback control menu 12 for controlling the playback of the first video V1 on the touch screen 151.

When the controller 180 receives a touch input with respect to a certain point t1 of the progress bar 10, the controller 180 may be configured to display a frame of a time point corresponding to a touch point as a frame screen P1.

Referring to (b) of FIG. 4, when it is determined that the first drag input I1 subsequent to a touch input with respect to the certain point t1 of the progress bar 10 drags the frame of the first video V1 to the frame screen P1, the controller 180 may be configured to display a screen for inserting the second video V2.

When the controller 180 receives the first drag input I1 subsequent to the touch input with respect to the certain point t1, the controller 180 may be configured to activate the camera 121 and provide a preview image of the camera 121 as the second video V2 in a predetermined area of the first video V1.

In FIG. 4, the controller 180 may be configured to receive the second drag input 12 which touches the preview image (i.e., the second video V2) of the camera 121 in a state where the user touch performing the first drag input I1 is maintained, and moves the second video V2 to another area.

Referring to (c) of FIG. 4, when the controller 180 receives the second drag input 12 which touches the preview image (i.e., the second video V2) of the camera 121 in a state where the user touch performing the first drag input I1 is maintained, and moves the second video V2 to another area, the controller 180 may be configured to move a position of the second video V2 depending on a direction of the second drag input 12.

Afterwards, when it is determined that the user touch is released, the controller 180 may be configured to start the recording of the preview image (i.e., the second video V2) of the camera 121. The controller 180 may be configured to record the second video V2 taken with the camera 121 from the certain point t1 of the first video V1 selected from the progress bar 10. In this instance, the controller 180 may be configured to insert the second video V2 into the first video V1 through a dual scene method, in which the first video V1 and the second video V2 taken with the camera 121 are displayed together, and record the second video V2.

The above embodiment described an example where the recording of the second video V2 automatically starts when the user touch performing the drag input I1 is released. However, a recording start/stop menu capable of selecting a start time point and a stop time point of the recording may be provided.

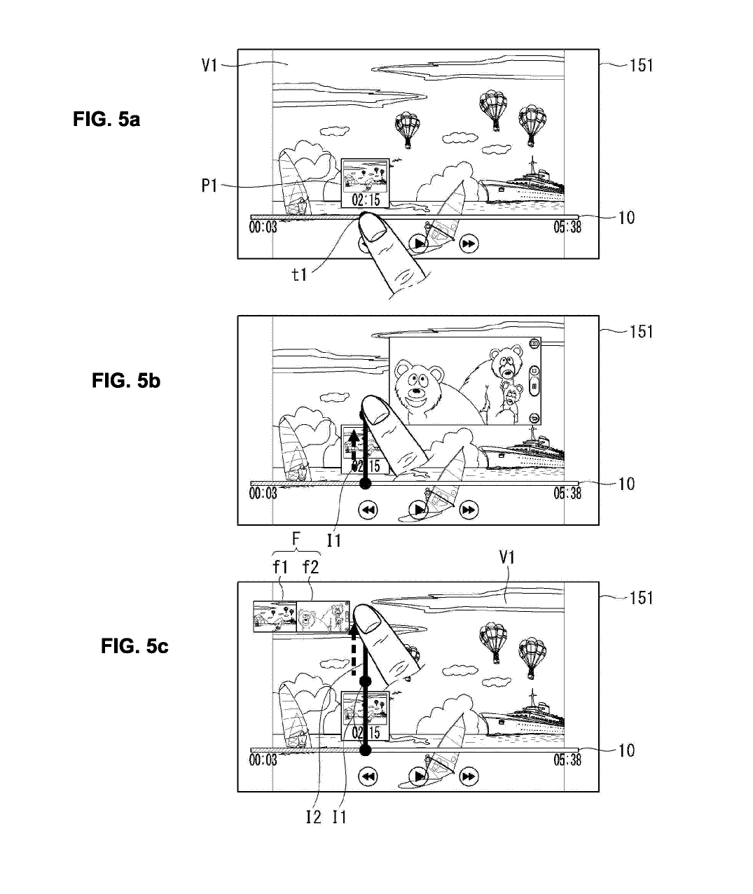

FIG. 5 illustrates an example of a screen display method when the user touches the progress bar 10 and then performs a second drag input 12 (extending a displacement) subsequent to a first drag input I1 displaying a second video V2.

Referring to (a) of FIG. 5, the controller 180 may be configured to display a first video V1 on the touch screen 151 and display the progress bar 10 and the playback control menu 12 for controlling the playback of the first video V1 on the touch screen 151.

When the controller 180 receives a touch input with respect to a certain point t1 of the progress bar 10, the controller 180 may be configured to display a frame of a time point corresponding to a touch point as a frame screen P1.

Referring to (b) of FIG. 5, when it is determined that the first drag input I1 subsequent to a touch input with respect to the certain point t1 of the progress bar 10 drags the frame of the first video V1 to the frame screen P1, the controller 180 may be configured to display a screen for inserting the second video V2. When the controller 180 receives the first drag input I1 subsequent to the touch input of the certain point t1, the controller 180 may be configured to activate the camera 121 and provide a preview image of the camera 121 as the second video V2 in a predetermined area of the first video V1.

In FIG. 5, the controller 180 may be configured to receive the second drag input 12 having a larger displacement, subsequent to the first drag input I1.

Referring to (c) of FIG. 5, when the controller 180 receives the second drag input 12 having the larger displacement in a state where the controller 180 receives the first drag input I1 and displays the second video V2, the controller 180 may be configured to display a split window F dividing a video taken with the camera. The split window F may display split frames including a first frame f1 and a second frame f2. The controller 180 may be configured to display the first video V1 on the first frame f1 and display the second video V2 on the second frame f2. Hence, the controller 180 may provide the second video V2 through the first frame f1 or the second frame f2 of the split window F, instead of a popup window providing the second video V2 in a predetermined area of the first video V1.

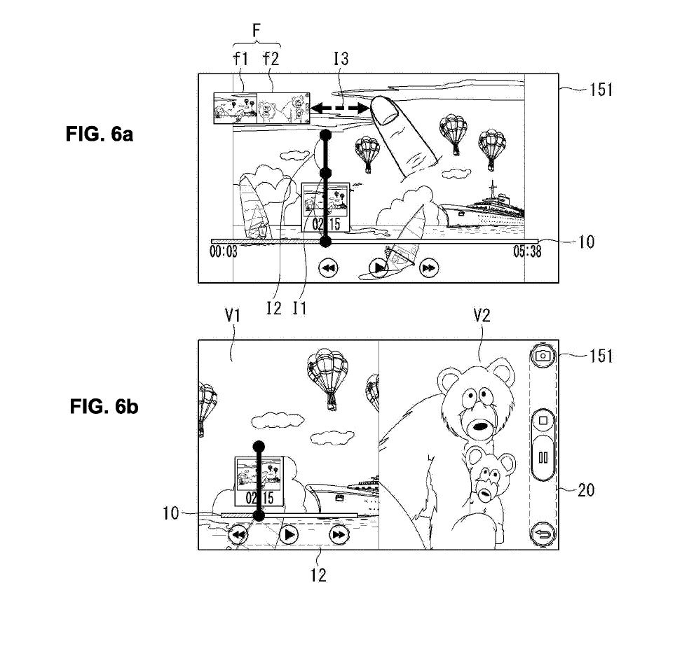

FIG. 6 illustrates an example of a process for controlling a recorded video using the split window F including the first frame f1 and the second frame f2 of FIG. 5.

Referring to (a) of FIG. 6, when the controller 180 receives a second drag input 12 having a larger displacement in a state where the controller 180 receives a first drag input I1 dragging a frame of a first video V1 to a frame screen P1 and displays a second video V2, the controller 180 may be configured to display the split window F dividing a taken video. The split window F may display divided frames including the first frame f1 and the second frame f2. The controller 180 may be configured to display the first video V1 on the first frame f1 and display the second video V2 on the second frame f2.

The controller 180 may be configured to receive a third drag input 13 dragging the split window F from side to side subsequent to the second drag input 12. The third drag input 13 may include an input (dragging the split window F from side to side) subsequent to the second drag input 12 without releasing a touch state of the second drag input 12.

When the controller 180 receives the third drag input 13 dragging the split window F from side to side, the controller 180 may be configured to change order of videos displayed on the first frame f1 and the second frame f2 depending on a drag direction.

When it is determined that the displacement of the third drag input 13 increases in direction getting out of the split window F, the controller 180 may be configured to change the number of split windows F or change a division direction of the split window F based on an increase in the displacement of the third drag input 13.

Referring to (b) of FIG. 6, when it is determined that a user touch performing the third drag input 13 is released, the controller 180 may be configured to display the split window F on the entire screen and start the recording based on a frame setting displayed on the entire screen. Hence, the controller 180 may be configured to display the first video V1 being played, the playback control menu 12, and the progress bar 10 on the first frame f1 of the touch screen 151 and also display the second video V2 being taken with the camera 121 and the camera control menu 20 on the second frame f2 of the touch screen 151.

The controller 180 may be configured to record the divided videos on the first and second frames subsequent to a certain point t1 of the first video V1 firstly selected from the progress bar 10. In this instance, the controller 180 may be configured to insert the second video V2 into the certain point t1 of the first video V1 or overwrite the second video V2 on the certain point t1 of the first video V1.

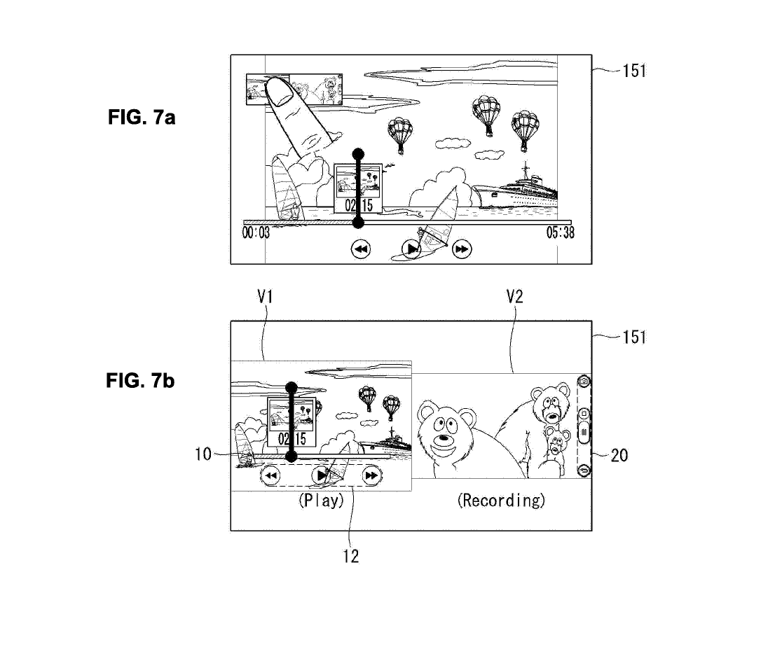

FIGS. 7 to 10 illustrate an example of a process for controlling a division state of a video being taken with the camera using the split window.

Referring to (a) of FIG. 7, when the controller 180 receives a touch input with respect to a certain point of the progress bar 10 and then receives a drag input, the controller 180 may be configured to perform a function corresponding to the input and display a split window F including a first frame f1 and a second frame f2. The controller 180 may be configured to display a first video V1 being played on the first frame f1 and display a preview image (i.e., a second video V2) of the camera 121 on the second frame f2.

Referring to (b) of FIG. 7, when it is determined that the user touch used to display the split window F is released, the controller 180 may be configured to start the recording in accordance with the setting of the split window F and display the split window F on the entire screen.

The controller 180 may be configured to display a first video V1 being played on the first frame f1 and display a preview image (i.e., a second video V2) of the camera 121 on the second frame f2. In this instance, the frame size of the first video V1 and the frame size of the second video V2 may be differently set depending on an aspect ratio, a resolution, and the like.

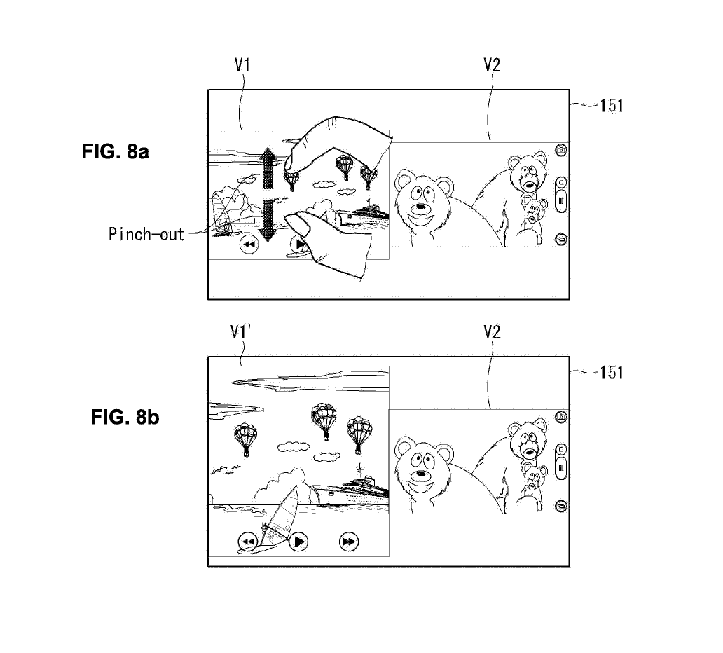

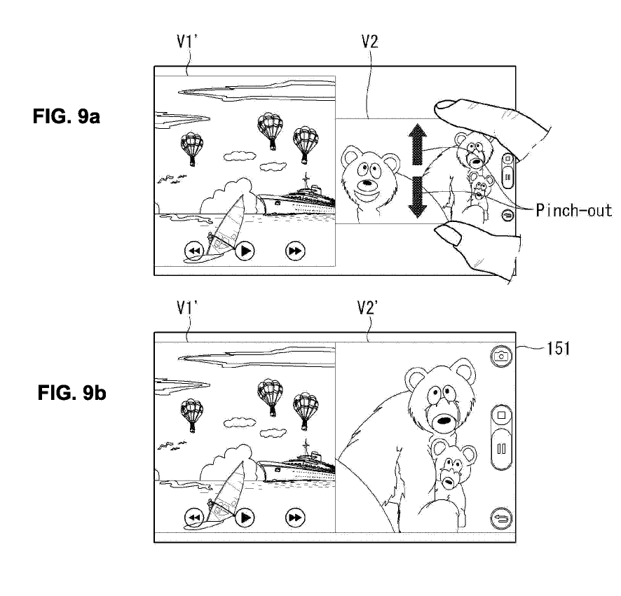

FIGS. 8 and 9 illustrate an example of a process for controlling sizes of divided frames.

Referring to (a) of FIG. 8, the controller 180 may be configured to display a video, which is now being recorded, on the display unit. The recorded video may include a first video V1 being played and a second video V2 being taken with the camera 121 respectively displayed on a first frame f1 and a second frame f2 divided from a frame. When the controller 180 receives a pinch-out input, which touches two points of the first frame f1 or the second frame f2 and then drags the two points away from each other in a longitudinal direction, the controller 180 may be configured to zoom in the corresponding screen in the longitudinal direction. Further, when the controller 180 receives a pinch-in input, which touches two points of the first frame f1 or the second frame f2 and then drags the two points closer to each other in the longitudinal direction, the controller 180 may be configured to zoon out the corresponding screen in the longitudinal direction.

Referring to (b) of FIG. 8, when the controller 180 receives a pinch-out input, which touches two points of the first frame f1 and then drags the two points away from each other in the longitudinal direction, the controller 180 may be configured to extend the first frame f1 in the longitudinal direction. Further, the controller 180 may be configured to display the first frame f1 extended through a user input and a first video V1′ zoomed in through an extension of the first frame f1 and record and store the video displayed on the screen.

Subsequently, referring to (a) of FIG. 9, the controller 180 may be configured to display a video, which is now being recorded, on the display unit. The sizes of the first and second frames f1 and f2, on which the video is displayed, may be different from each other. For example, as shown in (a) of FIG. 9, the size of the first frame f1 may be greater than the size of the second frame f2 in the longitudinal direction. Hence, the user may perform a pinch-out input, which touches two points of the second frame f2 and then drags the two points away from each other in the longitudinal direction, so that the size of the first frame f1 is substantially the same as the size of the second frame f2.

Referring to (b) of FIG. 9, when the controller 180 receives the pinch-out input, which touches two points of the second frame f2 and then drags the two points away from each other in the longitudinal direction, the controller 180 may be configured to extend the second frame f2 in the longitudinal direction. Further, the controller 180 may be configured to display the second frame f2 extended through a user input and a second video V2′ zoomed in through an extension of the second frame f2 and record the video displayed on the screen.

The above embodiment described an example where the frame size of the first video V1 and the frame size of the second video V2 are different from each other by a difference between the setting of the first video V1 and the setting of the second video V2. However, an aspect ratio of the taken video may be uniformly maintained by automatically adjusting an aspect ratio of each video when the frame is divided.

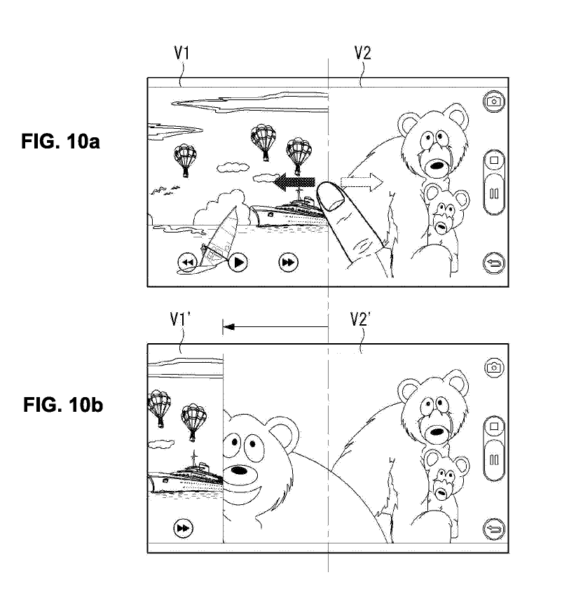

Referring to (a) of FIG. 10, the controller 180 may be configured to display a video, which is now being recorded, on the display unit. The recorded video may include a first video V1 being played and a second video V2 being taken with the camera 121 respectively displayed on a first frame f1 and a second frame f2 divided from a frame in the longitudinal direction. When the controller 180 receives an input, which selects a boundary line between the first frame f1 and the second frame f2 and then drags the boundary line from side to side, the controller 180 may be configured to move the boundary line in a drag direction and control the screen so that an area of one of the first and second frames f1 and f2 is larger than an area of the other.

Referring to (b) of FIG. 10, the controller 180 may be configured to receive a drag input, which selects a boundary line between the first frame f1 and the second frame f2 and then extend the second frame f2 toward the first frame f1. The controller 180 may be configured to move the boundary line to the first frame f1 in accordance with a received input and display the screen so that a horizontal width of the second frame f2 is greater than a horizontal width of the first frame f1. The controller 180 may be configured to display a first video V1′ on the first frame f1 and a second video V2′ on the second frame f2 based on the adjustment of the frame size.

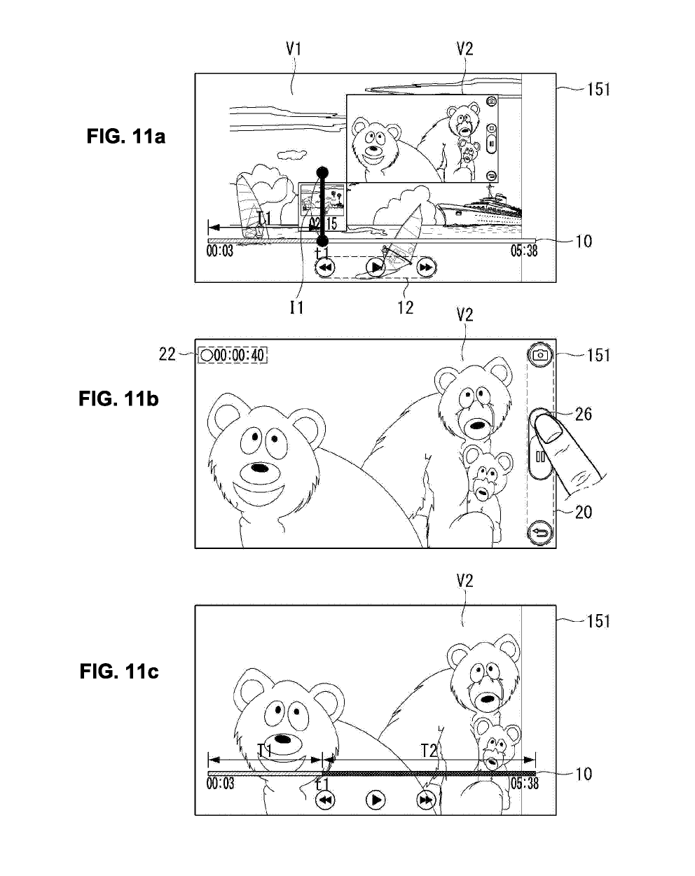

FIG. 11 illustrates an example of a process for inserting a second video V2 being taken with the camera 121 into a first video V1 being played, then stopping taking the second video V2, and storing an edited video.

Referring to (a) of FIG. 11, when it is determined that a drag input I1 subsequent to a touch input with respect to a certain point t1 of the progress bar 10 drags a frame of a first video V1 to a frame screen P1, the controller 180 may be configured to display a screen for inserting a second video V2. When the controller 180 receives the drag input I1 subsequent to the touch input with respect to the certain point t1, the controller 180 may be configured to activate the camera 121 and provide a preview image of the camera 121 as the second video V2 in a predetermined area of the first video V1.

Referring to (b) of FIG. 11, when it is determined that a user input performing the drag input I1 is released, the controller 180 may be configured to display the preview image (i.e., the second video V2) of the camera 121 on the entire screen of the touch screen 151 and start a recording of the second video V2. Hence, the touch screen 151 may display the second video V2 being recorded, the camera control menu 20, and the recording state notification 22.

The controller 180 may be configured to record the second video V2 taken with the camera 121 subsequent to the certain point t1 of the first video V1 selected from the progress bar 10. In this instance, the controller 180 may be configured to insert the second video V2 taken with the camera 121 into the certain point t1 of the first video V1 or overwrite the second video V2 taken with the camera 121 on the certain point t1 of the first video V1.

When the controller 180 receives a selection of a recording stop button 26 from the camera control menu 20, the controller 180 may be configured to stop recording the second video V2.

Referring to (c) of FIG. 11, when the controller 180 ends the insertion of the second video V2 by stopping recording the second video V2, the controller 180 may be configured to record the second video V2 taken with the camera 121 subsequent to the certain point t1 of the first video V1 selected from the progress bar 10. The controller 180 may be configured to separately display a time line T1, at which the first video V1 is stored, and a time line T2, at which the second video V2 is stored, on the progress bar 10.

Hence, the user can easily distinguish a stop time point of the first video V1 and a start time point of the second video V2 from the entire video through the progress bar 10.

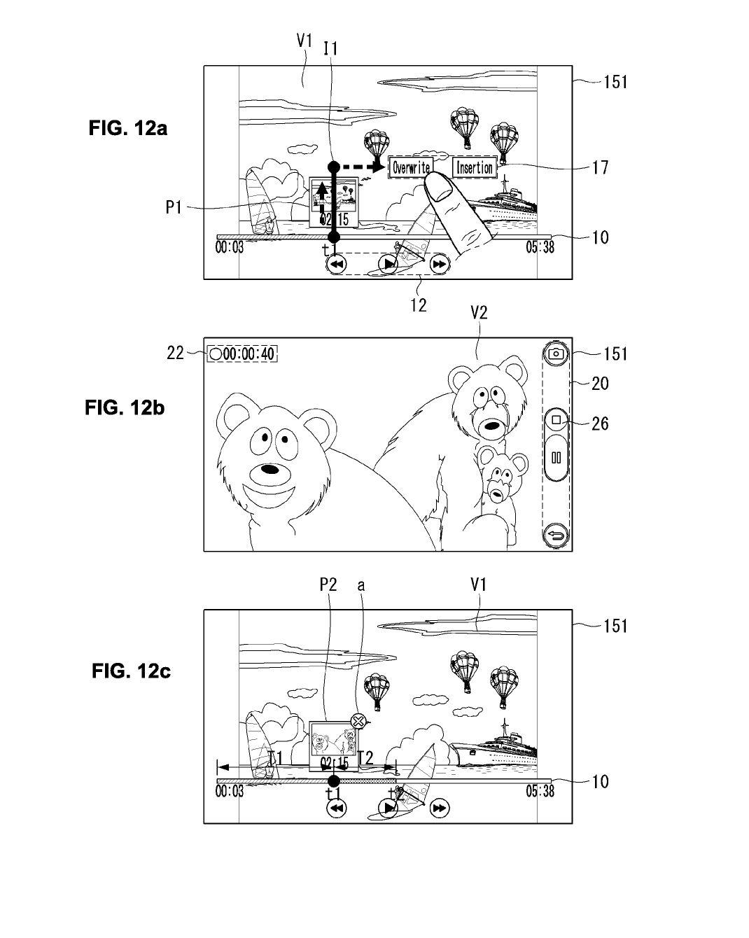

FIGS. 12 to 15 illustrate a method for controlling a mobile terminal according to a second embodiment of the invention. More specifically, FIGS. 12 to 15 illustrate an example of displaying a menu for inserting a video taken with a camera as a second video when an input with respect to a progress bar controlling playback of a first video is received.

The mobile terminal according to the second embodiment of the invention may provide a menu for an edit of the second video depending on a size of a displacement of a drag input in a direction away from the progress bar after the input with respect to the progress bar is received.

Referring to (a) of FIG. 12, the controller 180 may be configured to display a first video V1 on the touch screen 151 and display a progress bar 10 and a playback control menu 12 for controlling playback of the first video V1 on the touch screen 151.

When the controller 180 receives a touch input with respect to a certain point t1 of the progress bar 10, the controller 180 may be configured to display a frame of a time point corresponding to a touch point as a frame screen P1.

When it is determined that a first drag input I1 subsequent to the touch input with respect to the certain point t1 of the progress bar 10 is headed toward a display direction of the frame screen P1, the controller 180 may be configured to display an edit menu 17 for selecting a method for inserting a second video V2 taken with the camera 121. In this instance, the first drag input I1 may have a displacement which is equal to or greater than a first reference distance and is less than a second reference distance.

The edit menu 17 may include a menu for selecting one of a method for overwriting the second video V2 recorded with the camera 121 on the first video V1 being played, and a method for inserting the second video V2 into the first video V1. When an overwriting menu is selected, the controller 180 may be configured to overwrite the second video V2 from a time point of the first video V1 corresponding to the certain point t1 of the progress bar 10 and edit the first video V1. Further, when an insertion menu is selected, the controller 180 may be configured to insert the second video V2 from the time point of the first video V1 corresponding to the certain point t1 of the progress bar 10 and edit the first video V1 so that the first video V1 is played from the selected point t1 when the second video V2 ends.

Referring to (b) of FIG. 12, when it is determined that a user touch is released after the edit menu 17 is selected, the controller 180 may be configured to display a preview image (i.e., the second video V2) of the camera 121 on the entire screen of the touch screen 151 and start a recording of the second video V2. Hence, the touch screen 151 may display the second video being recorded, a camera control menu 20, and a recording state notification 22.

When the controller 180 receives a selection of a recording stop button 26 from the camera control menu 20, the controller 180 may be configured to stop recording the second video V2.

Referring to (c) of FIG. 12, when the recording of the second video V2 stops, the controller 180 may be configured to again display the first video V1 being played on the touch screen 151. When the controller 180 edits the first video V1 through the overwriting of the second video V2, the controller 180 may be configured to display the screen of the first video V1, which is played after a recording time of the second video V2 passed, on the touch screen 151.

After the controller 180 edits the first video V1 through the insertion of the second video V2, the controller 180 may be configured to display a frame P2 of the second video V2 at the time point t1, at which the second video V2 is inserted. When a touch input with respect to the frame P2 of the second video V2 is received, the controller 180 may be configured to play the second video V2 and display the second video V2 on the touch screen 151. The controller 180 may be configured to provide a close button “a” of the frame P2 of the second video V2, so that the frame P2 of the second video V2 is not displayed on the progress bar 10.

The controller 180 may be configured to separately display a time line T1, at which the first video V1 is stored, and a time line T2, at which the second video V2 is stored, on the progress bar 10.

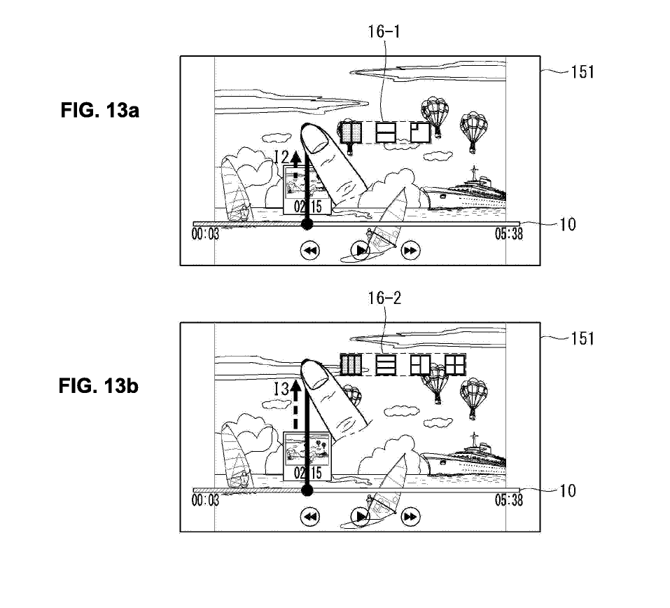

FIGS. 13 to 15 illustrate an example of providing split window menus 16-1 and 16-2 depending on changes in displacements of successive drag inputs after the controller displays the edit menu for selecting an insertion of a second video taken with the camera when receiving a drag input subsequent to a touch input with respect to a certain point t1 of the progress bar.

Referring to (a) of FIG. 13, the controller 180 may be configured to display a first video V1 on the touch screen 151 and display a progress bar 10 and a playback control menu 12 for controlling playback of the first video V1 on the touch screen 151.

When the controller 180 receives a touch input with respect to a certain point t1 of the progress bar 10, the controller 180 may be configured to display a frame of a time point corresponding to a touch point as a frame screen P1. When it is determined that a first drag input I1 subsequent to the touch input with respect to the certain point t1 is headed toward a display direction of the frame screen P1 and is dragged by a distance equal to or greater than a first reference distance, the controller 180 may be configured to display a menu (refer to FIG. 12) for inserting a second video V2.

In this instance, the controller 180 may be configured to receive a second drag input 12 having a larger displacement, subsequent to the first drag input I1. The second drag input may have a displacement which is equal to or greater than a second reference distance and is less than a third reference distance.

When the controller 180 receives the second drag input 12 having the larger displacement subsequent to the first drag input I1, the controller 180 may be configured to display a first split window menu 16-1 on the touch screen 151. The first split window menu 16-1 may provide a frame dividing the entire screen into two parts of first and second frames f1 and f2. The 2-division method may include a horizontally dividing method, a vertically dividing method, and a PIP dividing method.

Referring to (b) of FIG. 13, when the controller 180 receives a third drag input 13 having a larger displacement subsequent to the second drag input 12, the controller 180 may be configured to display a second split window menu 16-2 on the touch screen 151. The second split window menu 16-2 may provide a frame dividing the entire screen into three parts of first, second, and third frames f1, f2, and f3. The 3-division method may include a horizontally dividing method, a vertically dividing method, and a PIP dividing method.

After the controller 180 provides the split window menus 16-1 and 16-2 depending on the size of the displacement of the drag input, the controller 180 may be configured to provide a recorded screen based on the division method selected by the split window menus 16-1 and 16-2.

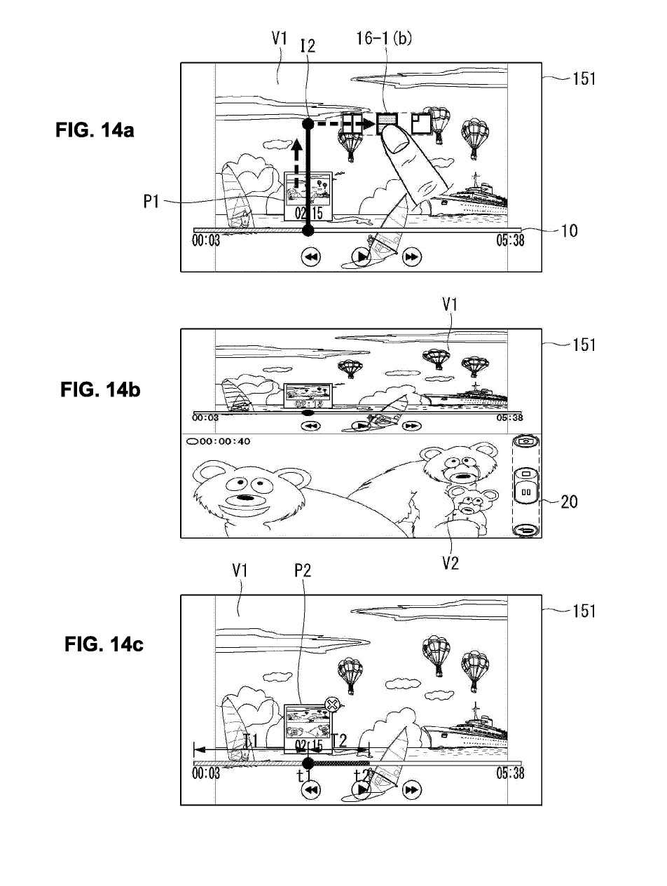

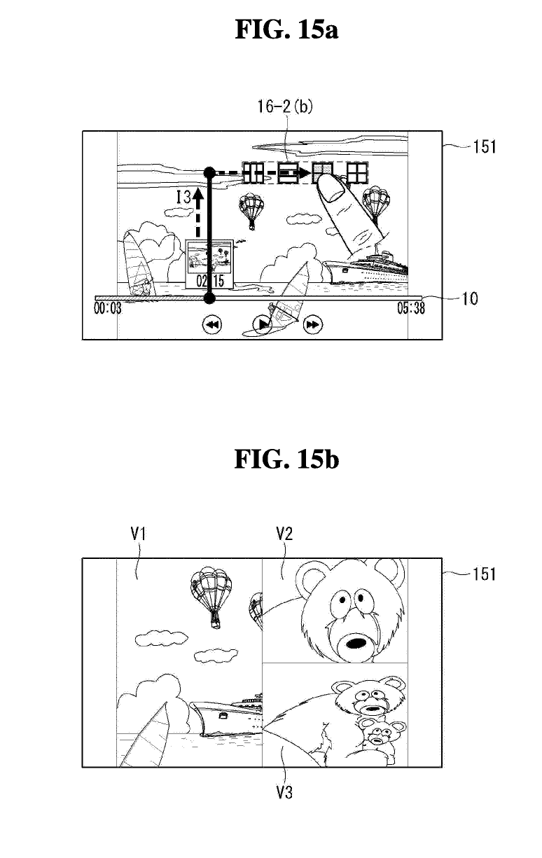

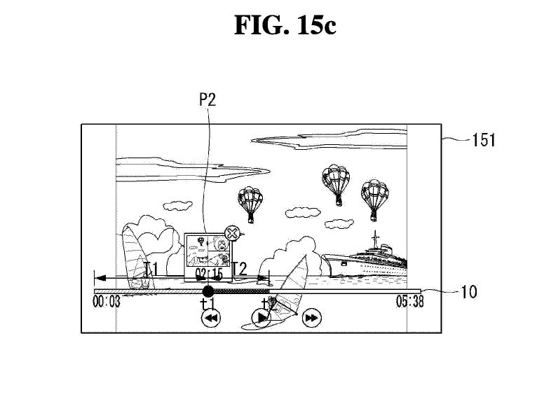

FIGS. 14 and 15 illustrate an example of a process for setting a recorded screen using the split window menus 16-1 and 16-2.

More specifically, FIG. 14 illustrates an example of a process for setting a recorded screen using the 2-division method. Referring to (a) of FIG. 14, when the controller 180 receives a touch input with respect to a certain point t1 of the progress bar 10, the controller 180 may be configured to display a frame of a time point corresponding to a touch point as a frame screen P1 and receive a second drag input 12 subsequent to the touch input. The second drag input 12 may have a displacement larger than a first drag input I1 displaying a menu (refer to FIG. 12) for inserting the second video V2.

When the controller 180 receives the second drag input 12, the controller 180 may be configured to display a first split window menu 16-1 on the touch screen 151. The first split window menu 16-1 may provide a frame dividing the entire screen into two parts of first and second frames f1 and f2. The 2-division method may include a horizontally dividing method, a vertically dividing method, and a PIP dividing method.

The controller 180 may be configured to receive an input of selecting one among items included in the first split window menu 16-1 subsequent to the second drag input 12. For example, the controller 180 may be configured to receive an input of selecting a menu 16-1(b) horizontally dividing the entire screen into two parts among the items included in the first split window menu 16-1.

Referring to (b) of FIG. 14, when it is determined that a user touch selecting the menu 16-1(b) is released, the controller 180 may be configured to display split windows F on the entire screen and start a recording based on a frame setting displayed on the entire screen.

Hence, the controller 180 may be configured to display a first video V1 being played, the progress bar 10, and the playback control menu 12 on the first frame f1 of the touch screen 151 and display a second video V2 being taken with the camera 121 and the camera control menu 20 on the second frame f2 of the touch screen 151.

Referring to (c) of FIG. 14, when the controller 180 receives a recording stop signal, the controller 180 may be configured to insert and store the second video V2 divided into the first and second frames subsequent to the time point t1 of the first video V1 selected from the progress bar 10. After, the controller 180 inserts the second video V2 and edits the first video V1, the controller 180 may be configured to display a frame P2 of the second video V2 at an insertion time point (i.e., t1) of the second video V2. When the controller 180 receives a touch input with respect to the frame P2 of the second video V2, the controller 180 may be configured to play the second video V2 and display the second video V2 on the touch screen 151.

FIG. 15 illustrates an example of a process for setting three split screens using the second split window menu 16-2.

Referring to FIG. 15a, when the controller 180 receives a touch input with respect to a certain point t1 of the progress bar 10, the controller 180 may be configured to display a frame of a time point corresponding to a touch point as a frame screen P1 and receive a third drag input 13 subsequent to the touch input. The third drag input 13 may have a displacement larger than the second drag input 12 displaying the first split window menu 16-1. Namely, the third drag input 13 may have a displacement equal to or greater than a third reference distance.

When the controller 180 receives the third drag input 13, the controller 180 may be configured to display a second split window menu 16-2 on the touch screen 151. The second split window menu 16-2 may provide a frame dividing the entire screen into three parts of first, second, and third frames f1, f2, and f3. The 3-division method may include a horizontally dividing method, a vertically dividing method, and a method dividing the entire screen into three parts at different aspect ratios.

The controller 180 may be configured to receive an input of selecting one among items included in the second split window menu 16-2 subsequent to the third drag input 13. For example, the controller 180 may be configured to receive an input of selecting a menu 16-2(b) dividing the entire screen into three parts at different aspect ratios among the items included in the second split window menu 16-2.

Referring to FIG. 15b, when it is determined that a user touch selecting the menu 16-2(b) is released, the controller 180 may be configured to display split windows F on the entire screen and start a recording based on a frame setting displayed on the entire screen.

Hence, the controller 180 may be configured to display a first video V1 being played on the first frame f1 of the touch screen 151, display a second video V2 being taken with the rear camera 121 on the second frame f2 of the touch screen 151, and display a third image V3 tracking and zooming in a predetermined portion of the second video V2 being taken with the rear camera 121 on the third frame f3 of the touch screen 151.

The video displayed on each frame may be changed depending on the selection of the user. For example, a video being played, a video being taken with a front camera, and a video being taken with a rear camera may be recorded on one screen. Further, when the number of cameras increases, the number of videos recorded on one screen may increase.

Referring to FIG. 15c, when the controller 180 receives a recording stop signal, the controller 180 may be configured to insert and store the second video V2 divided into the three frames subsequent to the time point t1 of the first video V1 selected from the progress bar 10. After, the controller 180 inserts the second video V2 and edits the first video V1, the controller 180 may be configured to display a frame P2 of the second video V2 at an insertion time point (i.e., t1) of the second video V2. When the controller 180 receives a touch input with respect to the frame P2 of the second video V2, the controller 180 may be configured to play the second video V2 and display the second video V2 on the touch screen 151.

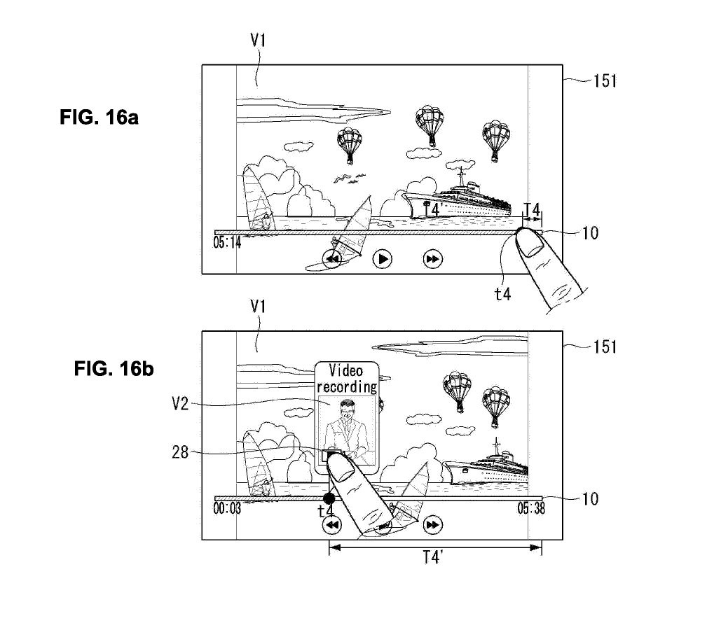

FIG. 16 illustrates a method for controlling a mobile terminal according to a third embodiment of the invention. More specifically, FIG. 16 illustrates an example of automatically providing a shooting menu, so that a second video is taken and inserted before a video being played ends.

Referring to (a) of FIG. 16, the controller 180 may be configured to display a first video V1 on the touch screen 151 and display a progress bar 10 and a playback control menu 12 for controlling playback of the first video V1 on the touch screen 151. The progress bar 10 may display a total playback time and a current playback position of the video. The progress bar 10 may include a playing head or a handler button indicating the current playback position.

When a remaining playback time of the first video V1 is equal to or less than a predetermined time T4, the controller 180 may be configured to provide a shooting menu for recording and inserting a second video V2 taken with the camera 121 subsequent to the first video V1. For example, when a remaining playback time of the first video V1 is three seconds, the controller 180 may be configured to display the playing head or the handler button as a red color or cause the playing head or the handler button to flicker. Hence, the user may recognize that the controller 180 can enter a menu for inserting the second video V2 taken with the camera 121.

Referring to (b) of FIG. 16, when the controller 180 receives a touch input with respect to the playing head or the handler button, the controller 180 may be configured to activate the camera 121, display a popup window in a predetermined area of the first video V1, and provide a preview image of the camera 121 as the second video V2.

The controller 180 may be configured to extend the progress bar 10 from the remaining playback time T4 of the first video V1 displayed at a time point t4, at which the second video V2 starts to be recorded, by a recordable time T4′.

Afterwards, when the recording stops, the controller 180 may be configured to record the second video V2 taken with the camera 121 subsequent to a stop time point of the first video V1. The controller 180 may be configured to separately display a storing time line of the first video V1 and a storing time line of the second video V2 on the progress bar 10.

As described above, when the controller 180 provides a menu for automatically taking and inserting the second video V2 while the first video V1 is played, the controller 180 may be configured to record the second video V2, so that the second video V2 has the same setting as the first video V1. For example, when the first video V1 has a specific format, for example, Instagram, the controller 180 may be configured to record the second video V2, so that the second video V2 has the same FPS and the same duration as the first video V1. Hence, the second video V2 may be subsequently pasted to the first video V1.

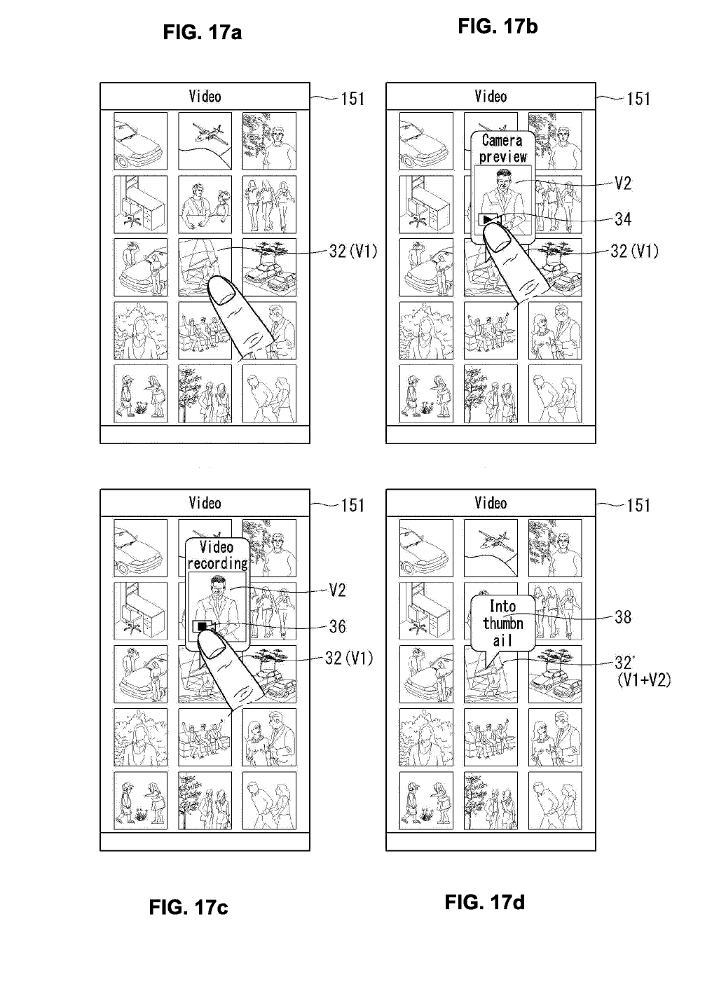

FIG. 17 illustrates a method for controlling a mobile terminal according to a fourth embodiment of the invention. More specifically, FIG. 17 illustrates an example of taking a second video and inserting the second video into a first video selected from a video list in a state where the first video is not played.

Referring to (a) of FIG. 17, the controller 180 may be configured to provide a list of video files stored in the mobile terminal. The video files included in the list may be displayed as thumbnails.

When the controller 180 receives a predetermined input with respect to a thumbnail 32 of a first video V1 selected from the list, the controller 180 may be configured to provide a shooting menu for inserting a second video V2 taken with the camera 121 into the first video V1. For example, when the controller 180 receives a long touch input with respect to the thumbnail 32 of the first video V1 selected from the list, the controller 180 may be configured to provide the shooting menu for inserting the second video V2 into the first video V1.

Referring to (b) of FIG. 17, when the controller 180 receives the long touch input with respect to the thumbnail 32 of the first video V1 selected from the list, the controller 180 may be configured to activate the camera 121, display a popup window in a predetermined area of the list, and provide a preview image of the camera 121 as the second video V2.

The controller 180 may be configured to provide a shooting selection button 34 for the preview image of the camera 121. When the shooting selection button 34 is selected, the controller 180 may be configured to record the preview image of the camera 121 and produce the second video V2.

Referring to (c) of FIG. 17, the controller 180 may be configured to provide a shooting stop button 36 for the preview image of the camera 121 and stop the shooting when the shooting stop button 36 is selected.

Referring to (d) of FIG. 17, when the shooting ends, the controller 180 may be configured to insert and store the second video V2 taken with the camera 121 subsequent to the first video V1. The controller 180 may be configured to display a message window 38 notifying that the second video V2 was stored in the first video V1 corresponding to the thumbnail 32. Hence, the controller 180 may be configured to display that an edited thumbnail 32′ of the first video V1 was stored.

When the second video V2 taken with the camera 121 is inserted into the first video V1 selected from the video list as described above, the controller 180 may be configured to record the second video V2, so that the second video V2 has the same setting as the first video V1. For example, when the first video V1 has a specific format, for example, Instagram, the controller 180 may be configured to record the second video V2, so that the second video V2 has the same FPS and the same duration as the first video V1. Hence, the second video V2 may be subsequently pasted to the first video V1.

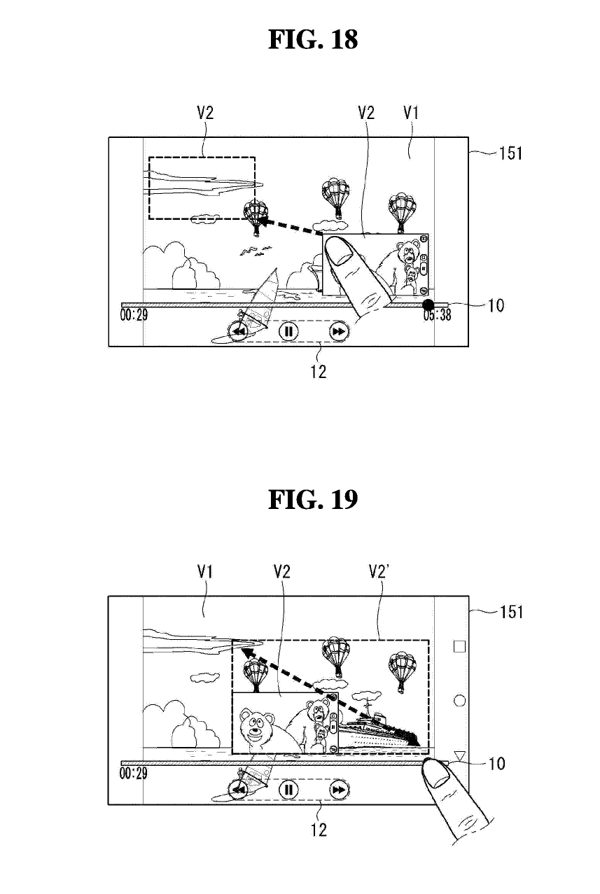

FIGS. 18 to 20 illustrate a method for controlling a mobile terminal according to a fifth embodiment of the invention. More specifically, FIGS. 18 to 20 illustrate an example of a method for providing a second video taken with the camera of the mobile terminal.

Referring to FIG. 18, when the controller 180 receives a drag input subsequent to a touch input with respect to a certain point of the progress bar 10, the controller 180 may be configured to activate the camera 121, display a popup window in a predetermined area of a first video V1, and provide a preview image of the camera 121 as a second video V2.

The controller 180 may be configured to receive a drag input of touching the preview image (i.e., the second video V2) of the camera 121 and moving the second video V2 to another area.

When the controller 180 receives the drag input of touching the second video V2 and moving the second video V2 to another area, the controller 180 may be configured to display a position of the second video V2 moving depending on a direction of the drag input.

The embodiment of the invention can provide the convenience for the user, that takes the second video V2 with the camera 121, by arbitrarily adjusting the position of the preview image (i.e., the second video V2) of the camera 121 as described above.

Referring to FIG. 19, when the controller 180 receives a drag input subsequent to a touch input with respect to a certain point of the progress bar 10, the controller 180 may be configured to activate the camera 121, display a popup window in a predetermined area of a first video V1, and provide a preview image of the camera 121 as a second video V2.

The controller 180 may be configured to adjust the size of the second video V2 depending on a user input with respect to the preview image (i.e., the second video V2) of the camera 121.

For example, when the controller 180 receives an input of touching a predetermined point of the second video V2 and then dragging the second video V2 in a zoom-in direction of the second video V2, the controller 180 may be configured to zoom in and display the second video V2. Further, when the controller 180 receives an input of touching a predetermined point of the second video V2 and then dragging the second video V2 in a zoom-out direction of the second video V2, the controller 180 may be configured to zoom out and display the second video V2.

In another embodiment, when the controller 180 receives a pinch-out input, which touches two points of the second video V2 and then drags the two points away from each other, the controller 180 may be configured to zoom in the second video V2. Further, when the controller 180 receives a pinch-in input, which touches two points of the second video V2 and then drags the two points closer to each other, the controller 180 may be configured to zoom out the second video V2.

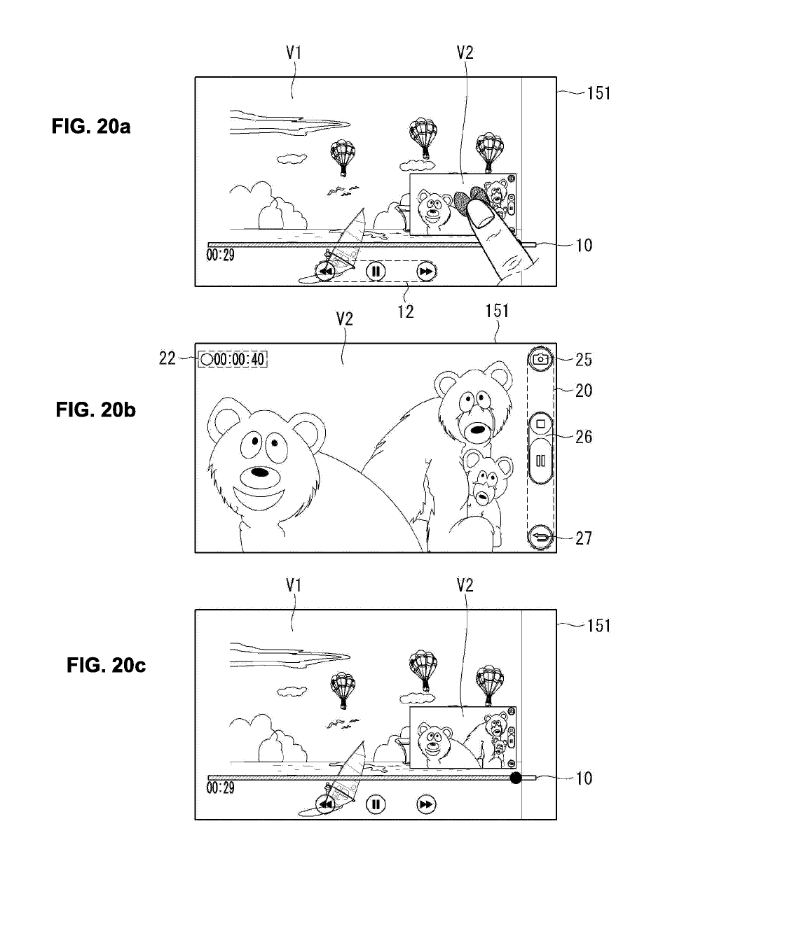

Referring to FIG. 20, when the controller 180 receives a drag input subsequent to a touch input with respect to a certain point of the progress bar 10, the controller 180 may be configured to activate the camera 121, display a popup window in a predetermined area of a first video V1, and provide a preview image of the camera 121 as a second video V2. In this instance, the second video V2 may be displayed near the progress bar 10 receiving the touch input.

Referring to (a) of FIG. 20, the controller 180 may be configured to receive a predetermined input with respect to the second video V2 displayed as the popup window in the predetermined area of the first video V1. For example, the controller 180 may be configured to receive a touch input of touching the second video V2 two times within a predetermined time.

Referring to (b) of FIG. 20, when the controller 180 receives the touch input of touching the second video V2 two times within a predetermined time, the controller 180 may be configured to display the preview image (i.e., the second video V2) of the camera 121 on the entire screen of the touch screen 151. The controller 180 may be configured to display the second video V2 being recorded, the camera control menu 20, and the recording state notification 22 on the touch screen 151.

The camera control menu 20 may include a photo button 25 taking the second video V2 as a photo, a recording button 26 taking the second video V2 as a video, and a previous screen button 27 returning to a previous screen.

When the controller 180 receives a selection of the recording button 26 from the camera control menu 20, the controller 180 may be configured to start or stop recording the second video V2.

Referring to (c) of FIG. 20, when the controller 180 receives a selection of the previous screen button 27 from the camera control menu 20, the controller 180 may be configured to display a previous screen. The controller 180 may be configured to display the first video V1 on the entire screen of the touch screen 151, display a popup window in a predetermined area of the first video V1, and provide a preview image of the camera 121 as a second video V2.

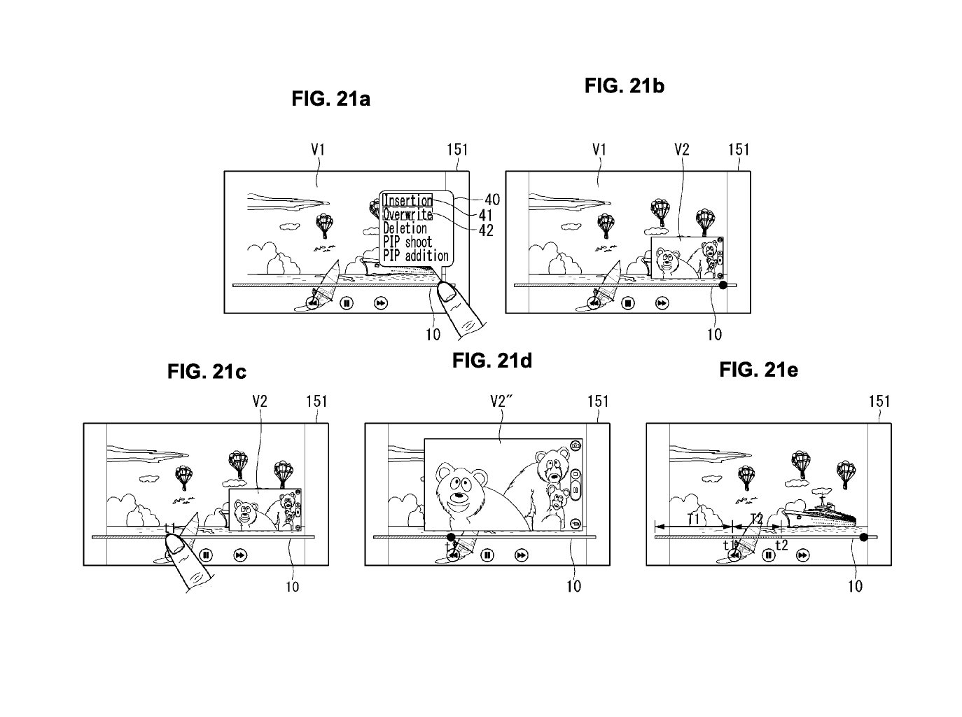

FIGS. 21 to 28 illustrate a method for controlling a mobile terminal according to a sixth embodiment of the invention. More specifically, FIGS. 21 to 28 illustrate an example of displaying a second video insertion menu for inserting a second video taken with the camera 121 into a first video being played on the touch screen 151 in real time.

A second video insertion menu 40 may include various menus for inserting a second video V2 taken with the camera 121 into a first video V1 being played on the touch screen 151 in real time. For example, the second video insertion menu 40 may include an insertion, an overwriting, a deletion, a chroma key shoot, a PIP shoot, a PIP addition, etc.

Referring to (a) of FIG. 21, the controller 180 may be configured to display the first video V1 and the progress bar 10 for controlling playback of the first video V1 on the touch screen 151.

When the controller 180 receives a predetermined input with respect to the progress bar 10, the controller 180 may be configured to display the second video insertion menu 40 for inserting the second video V2. For example, when the controller 180 receives a long touch input with respect to the progress bar 10, the controller 180 may be configured to display the second video insertion menu 40. Further, the controller 180 may be configured to provide a separate menu for selecting the display of the second video insertion menu 40.

An insertion menu 41 or an overwriting menu 42 of the second video insertion menu 40 is a menu for selecting inserting or overwriting the second video V2 taken with the camera 121 into or on the first video V1. In the following description, the insertion menu 41 is selected as an example.

Referring to (b) of FIG. 21, when the controller 180 receives a selection signal with respect to the insertion menu 41 of the second video insertion menu 40, the controller 180 may be configured to display a popup window in a predetermined area of the first video V1 and provide a preview image of the camera 121 as the second video V2.

Referring to (c) of FIG. 21, the controller 180 may be configured to receive a touch input with respect to a predetermined point t1 of the progress bar 10, at which the second video V2 will be inserted. When the predetermined point t1 of the progress bar 10, at which the second video V2 will be inserted, is selected, the controller 180 may be configured to insert the second video V2 at the predetermined point t1.

Referring to (d) of FIG. 21, when the controller 180 receives a predetermined input while the second video V2 is recorded, the controller 180 may be configured to zoom in the second video V2 and display a zoomed-in second video V2′. For example, when the controller 180 receives a pinch-out input, which touches two points of the second video V2 and then drags the two points away from each other, the controller 180 may be configured to zoom in the second video V2. Further, when the controller 180 receives a pinch-in input, which touches two points of the second video V2 and then drags the two points closer to each other, the controller 180 may be configured to zoon out the second video V2.

Referring to (e) of FIG. 21, when the recording of the second video V2 stops, the controller 180 may be configured to insert the second video V2 taken with the camera 121 subsequent to the predetermined point t1 of the first video V1 selected from the progress bar 10 and store the second video V2. The controller 180 may be configured to separately display a time line T1, at which the first video V1 is stored, and a time line T2, at which the second video V2 is stored, on the progress bar 10. The second video V2 may be inserted from a time point corresponding to the predetermined point t1 of the first video V1 selected from the progress bar 10. Hence, a playback time of an edited video may increase by a playback time of the second video V2. When the edited video is played, the second video V2 may start to be played at the predetermined point t1 of the first video V1. When the second video V2 ends, the first video V1, which is not played and remains after the selected point t1 of the first video V1, is played.

When the overwriting menu 42 of the second video insertion menu 40 is selected, the controller 180 may be configured to overwrite the second video V2 for a period of time from a time point corresponding to the predetermined point t1 of the first video V1 selected from the progress bar 10 to an end time point t2 of the second video V2 and edit the first video V1. Namely, the first video V1 recorded for the period of time from the time point corresponding to the predetermined point t1 of the first video V1 to the end time point t2 of the second video V2 may be deleted, and the second video V2 may be inserted for the period of time instead. Hence, when the edited video is played, the second video V2 may start to be played from the predetermined point t1 of the first video V1, and the first video V1 may be again played from the end time point t2 of the second video V2 when the second video V2 ends.

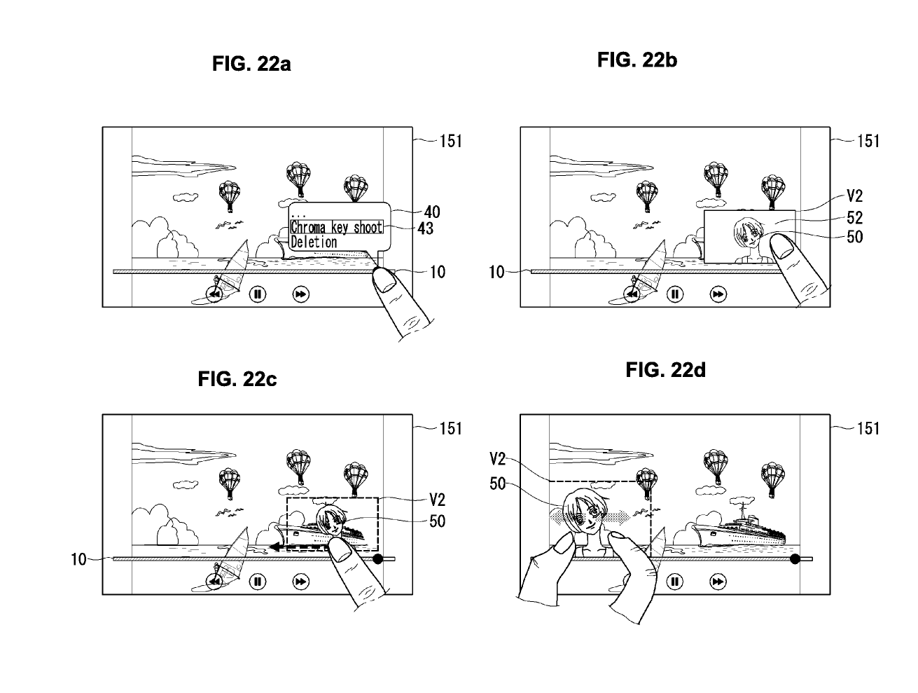

Referring to (a) of FIG. 22, when a predetermined input with respect to the progress bar 10 is received or a separate menu is selected, the controller 180 may be configured to display the second video insertion menu 40.

A chroma key shoot menu 43 of the second video insertion menu 40 may be provided.

Referring to (b) of FIG. 22, when the controller 180 receives a selection signal of the chroma key shoot menu 43, the controller 180 may be configured to display a popup window in a predetermined area of a first video V1 and provide a preview image of the camera 121 as a second video V2. A second video V2 may include a subject 50 and a background 52.

When the controller 180 receives a predetermined input with respect to the background 52 of the second video V2 while providing a function of the chroma key shoot menu 43, the controller 180 may be configured to control transparency of the background 52 except the subject 50.

Referring to (c) of FIG. 22, when the controller 180 receives a predetermined input, for example, a long touch input with respect to the background 52 of the second video V2, the controller 180 may be configured to transparently display the background 52 except the subject 50. Afterwards, the controller 180 may be configured to receive a drag input of touching the second video V2 and moving the second video V2 to another area.

Referring to (d) of FIG. 22, when the controller 180 receives the drag input of touching the second video V2 and moving the second video V2 to another area, the controller 180 may be configured to display a position of the second video V2 moving depending on a direction of the drag input. Further, when the controller 180 receives a predetermined input with respect to the second video V2, the controller 180 may be configured to zoom in or out the second video V2.

For example, when the controller 180 receives a pinch-out input, which touches two points of the second video V2 and then drags the two points away from each other, the controller 180 may be configured to zoom in the second video V2. Further, when the controller 180 receives a pinch-in input, which touches two points of the second video V2 and then drags the two points closer to each other, the controller 180 may be configured to zoom out the second video V2.

The embodiment of the invention described that the chroma key shoot is applied to the second video V2 taken with camera 121. However, the chroma key shoot may be applied to the first video V1. For example, the controller 180 may transparently display a background except a subject of the first video V1 and use the second video V2 taken with camera 121 as the background of the first video V1.

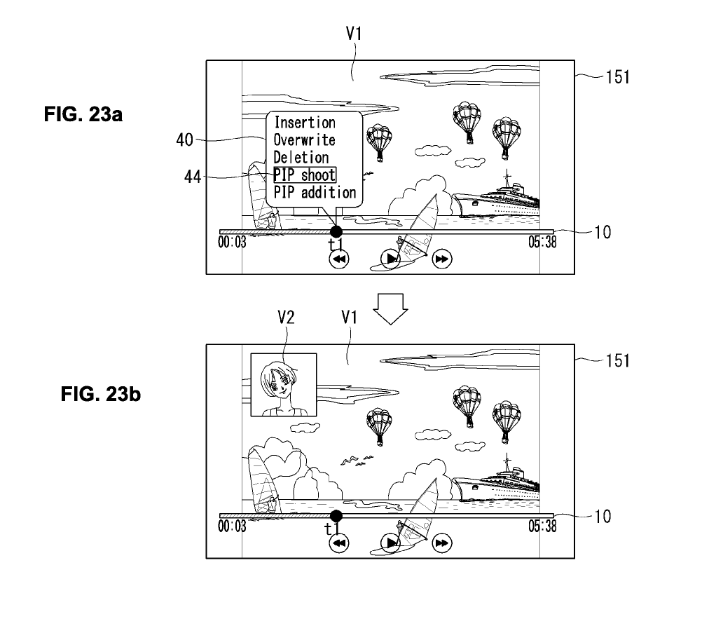

Referring to (a) of FIG. 23, the controller 180 may be configured to display a first video V1 and the progress bar 10 for controlling playback of the first video V1 on the touch screen 151. When a predetermined input with respect to the progress bar 10 is received or a separate menu is selected, the controller 180 may be configured to display the second video insertion menu 40.

A PIP shoot menu 44 of the second video insertion menu 40 may be provided. The PIP shoot menu 44 may be a menu for recording a PIP video including a main screen displayed on an entire screen and a subscreen displayed on a portion of the main screen. In particular, the PIP shoot menu 44 may be a menu for recording a PIP video including a video taken with the camera 121 in real time.

Referring to (b) of FIG. 23, when the controller 180 receives a selection signal of the PIP shoot menu 44, the controller 180 may be configured to display the subscreen in a predetermined area of the first video V1 corresponding to the main screen, provide a preview image of the camera 121 as a second video V2, and record the screen displayed on the touch screen 151. Namely, the controller 180 may be configured to record a video, in which the second video V2 being taken with the camera 121 is displayed on the first video V1 corresponding to the main screen as the subscreen.

The controller 180 may be configured to record the PIP video including the second video V2 corresponding to the subscreen from a predetermined point t1 selected from the progress bar 10.

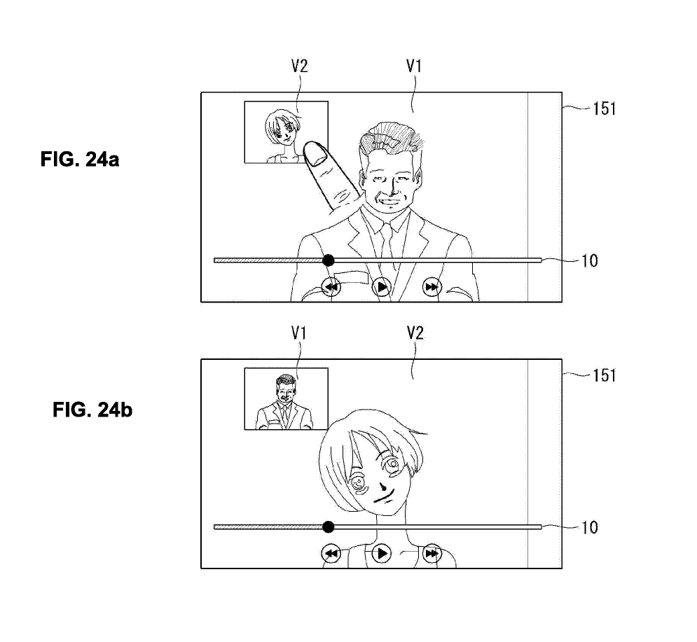

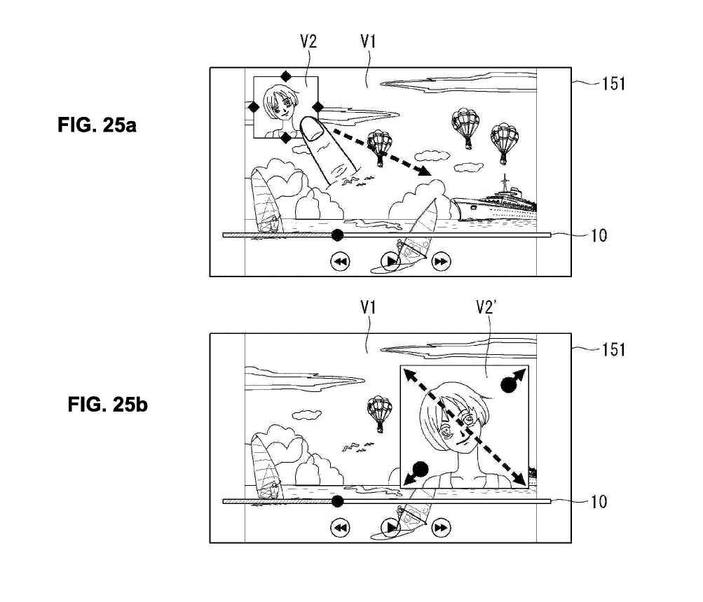

FIGS. 24 and 25 illustrate an example of a method for controlling a PIP window, on which a second video is displayed.

Referring to (a) of FIG. 24, when the PIP shoot menu 44 is selected, the controller 180 may be configured to display a subscreen in a predetermined area of a first video V1 corresponding to a main screen on the touch screen 151 and provide a preview image of the camera 121 as a second video V2.

The controller 180 may be configured to receive a predetermined input, for example, a long touch input with respect to the second video V2 displayed on the subscreen.

Referring to (b) of FIG. 24, when the controller 180 receives the long touch input with respect to the second video V2 displayed on the subscreen, the controller 180 may be configured to reverse a video of the main screen and a video of the subscreen. Namely, the controller 180 may be configured to display the preview image of the camera 121 as the second video V2 on the main screen and display the first video V1 being played on the subscreen.

Referring to (a) of FIG. 25, when the PIP shoot menu 44 is selected, the controller 180 may be configured to display a subscreen in a predetermined area of a first video V1 corresponding to a main screen on the touch screen 151 and provide a preview image of the camera 121 as a second video V2.

The controller 180 may be configured to receive a predetermined input, for example, an input of touching and dragging the second video V2 displayed on the subscreen, a pinch-out input of touching two points of the second video V2 and then dragging the two points away from each other, or a pinch-in input of touching two points of the second video V2 and then dragging the two points closer to each other.

Referring to (b) of FIG. 25, when the controller 180 receives the input of touching and dragging the second video V2 displayed on the subscreen, the controller 180 may be configured to move the second video V2 to a position obtained after the drag input is performed.

When the controller 180 receives the pinch-out input of touching two points of the second video V2 and then dragging the two points away from each other, the controller 180 may be configured to zoom in the second video V2. Further, when the controller 180 receives the pinch-in input of touching two points of the second video V2 and then dragging the two points closer to each other, the controller 180 may be configured to zoom out the second video V2.

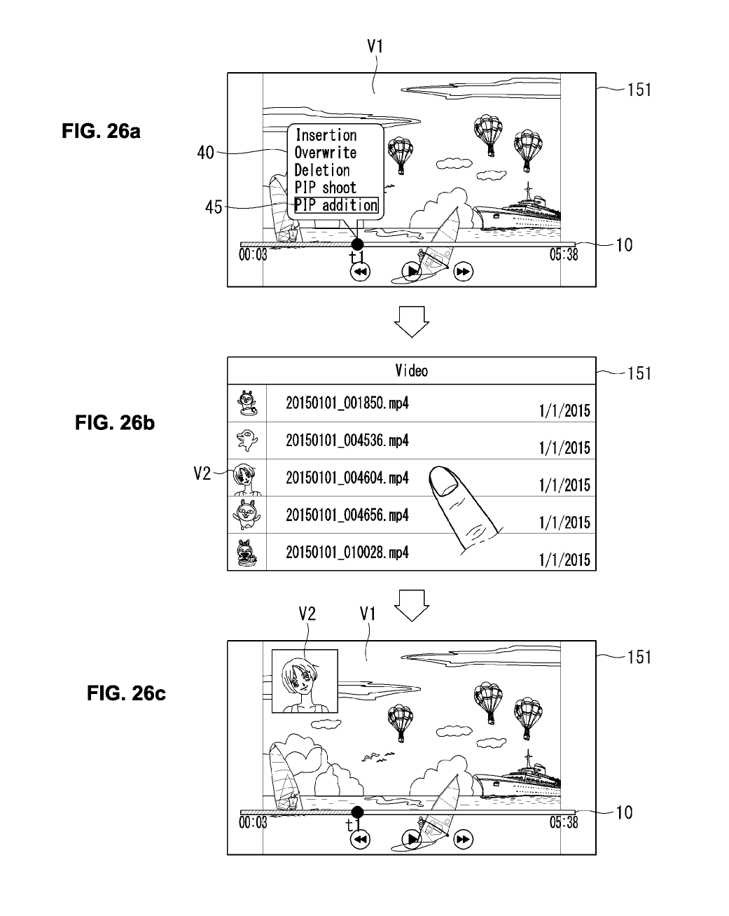

Referring to (a) of FIG. 26, the controller 180 may be configured to display a first video V1 and the progress bar 10 for controlling playback of the first video V1 on the touch screen 151. When a predetermined input with respect to the progress bar 10 is received or a separate menu is selected, the controller 180 may be configured to display the second video insertion menu 40.

A PIP addition menu 45 of the second video insertion menu 40 may be provided. The PIP addition menu 45 may be a menu for recording a PIP video including a main screen displayed on an entire screen and a subscreen displayed on a portion of the main screen. In particular, the PIP addition menu 45 may be a menu for recording a PIP video including a video that has been already taken with the camera 121 and stored.

Referring to (b) of FIG. 26, when the controller 180 receives a selection signal of the PIP addition menu 45, the controller 180 may be configured to display a list of videos, that have been already taken with the camera 121 and stored, on the touch screen 151. The controller 180 may be configured to receive an input of selecting a second video V2 from the video list.

Referring to (c) of FIG. 26, when the controller 180 receives the input of selecting the second video V2 from the video list, the controller 180 may be configured to display the subscreen in a predetermined area of the first video V1 corresponding to the main screen, provide a video selected from the video list as the second video V2, and record the screen displayed on the touch screen 151. Namely, the controller 180 may be configured to record a video, in which the second video V2, that had been already taken with the camera 121 and stored, is displayed on the first video V1 corresponding to the main screen as the subscreen.

The controller 180 may be configured to record the PIP video including the second video V2 corresponding to the subscreen from a predetermined point t1 selected from the progress bar 10.

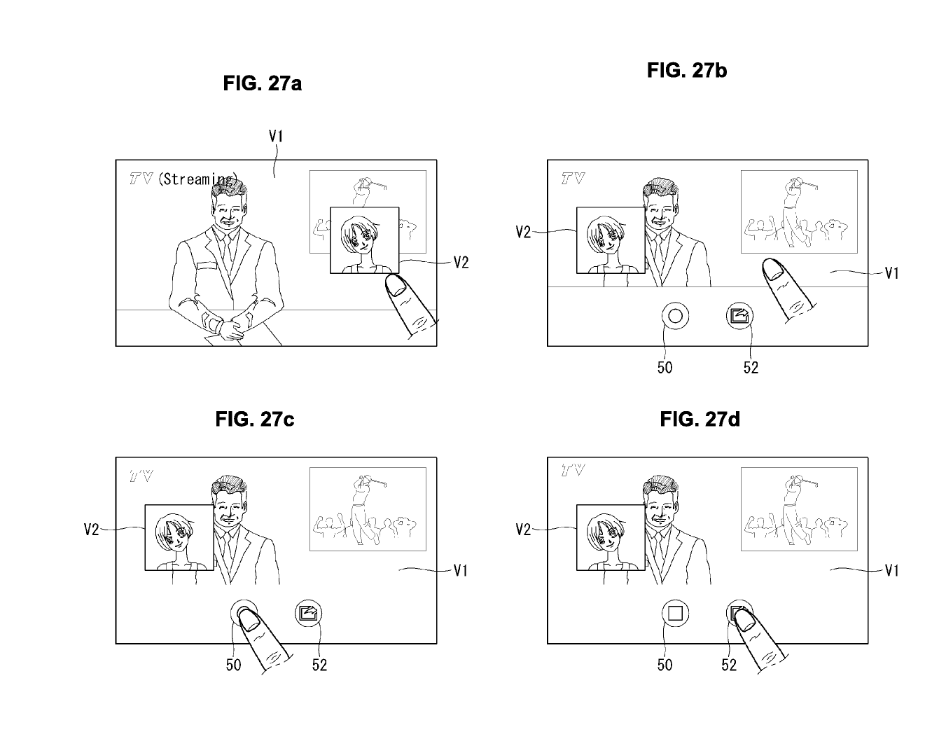

FIG. 27 illustrates an example of a method for inserting a second video, that is taken with the camera 121 in real time, into a first video corresponding to a streaming video and recording the second video.

Referring to (a) of FIG. 27, the controller 180 may be configured to display a first video V1 corresponding to a streaming video on the touch screen 151. The first video V1 may be a streaming video received through the wireless communication unit 110 (refer to FIG. 1) in real time and may be displayed without the progress bar. The first video V1 may include a video received from an external streaming server or a broadcast server, for example, DMB.

The controller 180 may be configured to receive a predetermined input, for example, a long touch input of the first video V1 while displaying the first video V1 corresponding to the streaming video. When the controller 180 receives the predetermined input, the controller 180 may be configured to display a subscreen in a predetermined area of the first video V1 and provide a preview image of the camera 121 as a second video V2.

Referring to (b) of FIG. 27, when the controller 180 receives the predetermined input, the controller 180 may be configured to provide a recording menu 50 for recording a video, in which the second video V2 being taken with the camera 121 is displayed on the first video V1 corresponding to a main screen as the subscreen, and storing the video and provide a broadcasting menu 52. For example, when the controller 180 receives an input of touching the first video V1 or the second video V2 for a period of time shorter than a reference time, the controller 180 may be configured to provide the recording menu 50 and the broadcasting menu 52.

When the controller 180 receives a predetermined input with respect to the second video V2 displayed on the subscreen, the controller 180 may be configured to move the second video V2 or zoom in or out the second video V2.

When the mobile terminal includes a plurality of cameras, the controller 180 may change a camera providing the second video V2 depending on a user selection.

Referring to (c) of FIG. 27, when the controller 180 receives an input of selecting the recording menu 50, the controller 180 may be configured to generate and record a video, in which the second video V2 being taken with the camera 121 is displayed on the first video V1 corresponding to the main screen as the subscreen.

Referring to (d) of FIG. 27, when the controller 180 receives an input of selecting the broadcasting menu 52, the controller 180 may be configured to transmit the recorded video through real-time streaming processing. For example, the controller 180 may be configured to transmit the recorded video to website (e.g., Youtube) providing a video streaming service through streaming processing.

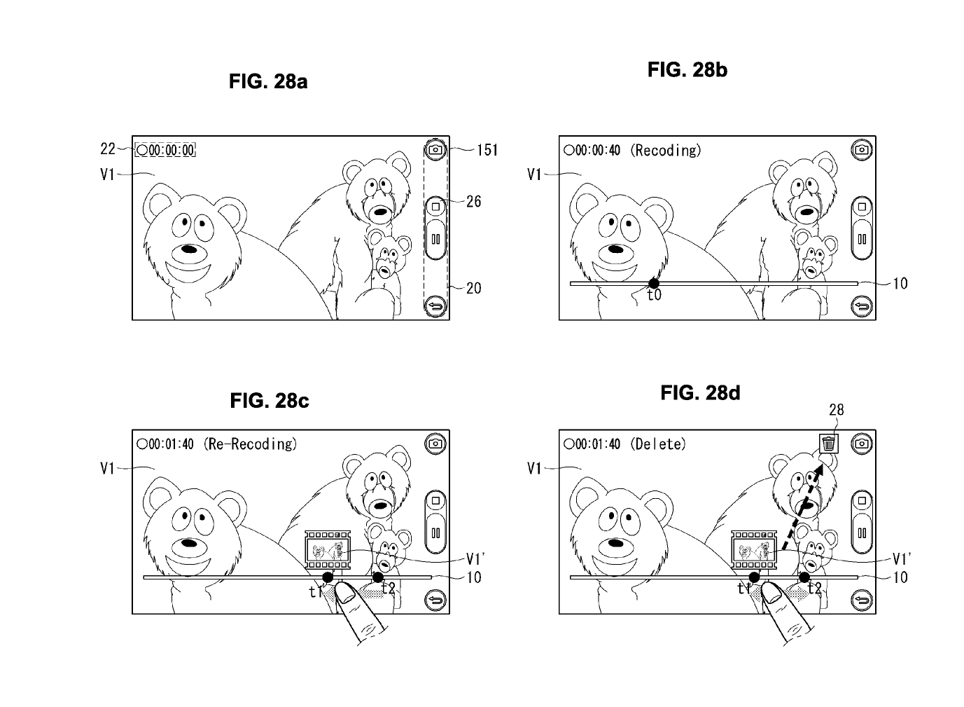

FIG. 28 illustrates an example of a method for controlling and editing a video being taken with the camera 121 using the progress bar.

Referring to (a) of FIG. 28, the controller 180 may be configured to display a first video V1 corresponding to a preview image of the camera 121 on the touch screen 151 as an entire screen and start the recording. The controller 180 may be configured to display the first video V1 being recorded, a camera control menu 20 including a recording stop button 26, and a recording state notification 22 on the touch screen 151.

Referring to (b) of FIG. 28, the controller 180 may be configured to display the first video V1 being recorded and the progress bar 10 displaying a recording time as a time line. The progress bar 10 may include a handler button displaying a time point t0 of a currently recorded video with respect to a total recordable time.

Referring to (c) of FIG. 28, the controller 180 may be configured to receive a user input of touching a first point t2 of the progress bar 10 and then dragging from the first point t2 to a second point t1 prior to the first point t2. The controller 180 may be configured to a frame corresponding to a time line of the second point t1, at which the drag ends, as a frame screen V1′.

When it is determined that the user input is released after dragging from the first point t2 to the second point t1, the controller 180 may be configured to rerecord a motion picture of a drag time between the first and second points t1 and t2 of the progress bar 10 and insert the rerecord motion picture into the drag time.

Referring to (d) of FIG. 28, when the controller 180 receives a drag input of moving from the first point t2 to the second point t1 in a state where the recording of the motion picture is paused, the controller 180 may be configured to delete the motion picture of a drag time between the first and second points t1 and t2 and display a deletion icon 28.

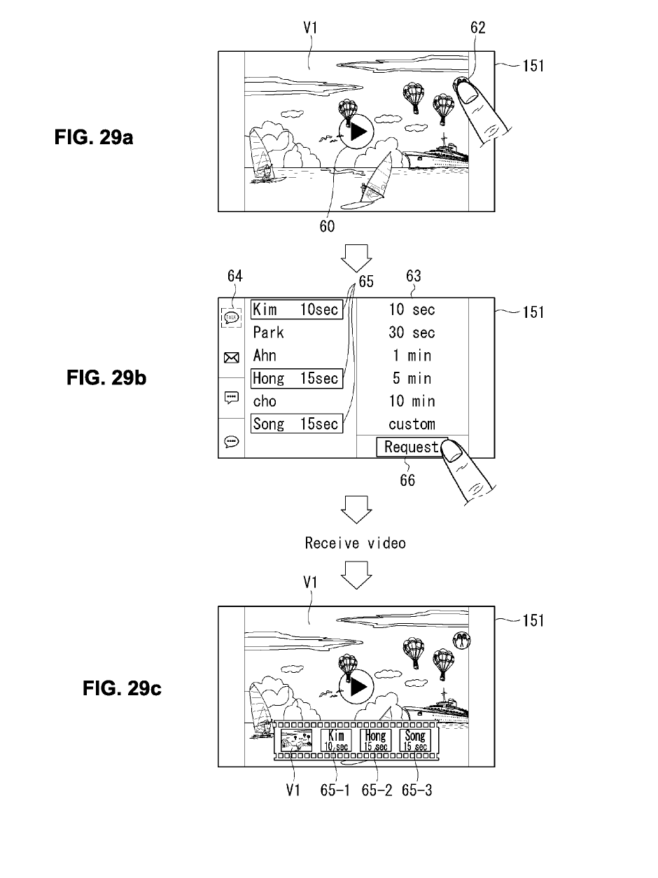

FIGS. 29 to 32 illustrate a method for controlling a mobile terminal according to a seventh embodiment of the invention. More specifically, FIGS. 29 to 32 illustrate an example of a method for editing videos received from other mobile terminals. The mobile terminal according to the seventh embodiment of the invention may receive videos taken by other users, edit a video by pasting the received videos to a video taken with the mobile terminal, and store the edited video.

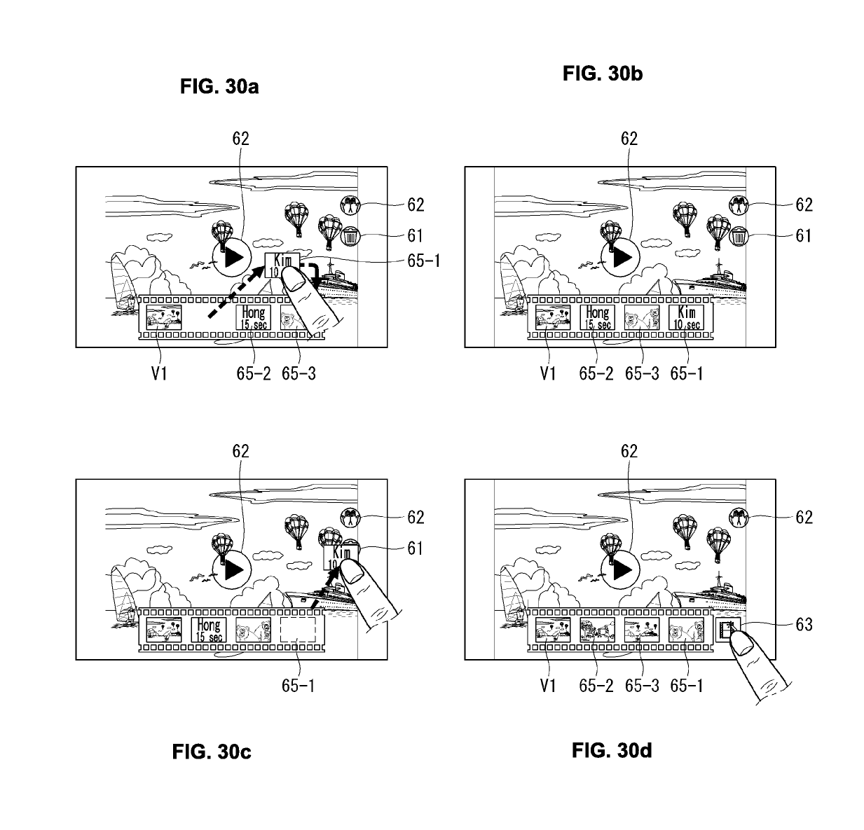

FIGS. 29 and 30 illustrate an example of a method for storing received videos as one video after requesting a video taken by another user.

Referring to FIG. 29, the controller 180 may be configured to display a first video V1, the user wants to edit, on the touch screen 151. The controller 180 may be configured to display a preview screen of the first video V1, a playback start button 60, and a video request button 62.

Referring to (a) of FIG. 29, the controller 180 may be configured to receive a selection signal of the video request button 62 provided along with the first video V1.

Referring to (b) of FIG. 29, when the controller 180 receives the selection signal of the video request button 62, the controller 180 may be configured to display a setting screen, which requests other users a video, on the touch screen 151.

The setting screen requesting the video may include a menu for selecting an application used to receive a video, a user which is asked to transmit a video, and a length of a requested video.

The controller 180 may receive an application 64 used to receive a video, a user 65 which is asked to transmit a video, and a length 63 of a requested video from the user. When a request menu 66 is selected after the reception is completed, the controller 180 may be configured to request the other user a video through an application selected by the user. For example, the controller 180 may request the other, “Kim”, a video of 10 seconds, the other, “Hong”, a video of 15 seconds, and the other, “Song”, a video of 15 seconds through an application of “Talk”.

Referring to (c) of FIG. 29, after the controller 180 receives videos from the users, which is requested to transmit the video, the controller 180 may be configured to paste the received videos to the first video V1 and store the pasted videos as one video.

After the video request is completed, the controller 180 may be configured to set slots as many as the number of users, which is requested to transmit the video, insert received videos into the slots, and edit received videos as one video.

FIG. 30 illustrates an example of a method for editing a slot, in which a received video is inserted and stored. The controller 180 may be configured to assign a first video V1 of the user to a first slot of a video the user wants to edit, a video 65-1 of the user “Kim” to a second slot, a video 65-2 of the user “Hong” to a third slot, and a video 65-3 of the user “Song” to a fourth slot. When the controller 180 receives a video from the user after setting the video of the user to be inserted into each slot, the controller 180 may be configured to display a frame screen of the received video and display a name of the user, who has to transmit the video, when the video is not yet received. When the controller 180 receives a predetermined input with respect to each slot, the controller 180 may be configured to change order of the corresponding slot or delete the corresponding slot.

Referring to (a) of FIG. 30, the controller 180 may be configured to receive an input of touching a predetermined slot and then dragging the predetermined slot to a position of another slot. For example, the controller 180 may a user input of touching the video 65-1 of the user “Kim” assigned to the second slot and then dragging the second slot to a position of the last slot.

Referring to (b) of FIG. 30, when the controller 180 receives an input of touching a predetermined slot and then dragging the predetermined slot to a position of another slot, the controller 180 may be configured to change order of the predetermined slot. For example, the controller 180 may move the video 65-1 of the user “Kim” assigned to the second slot to the fourth slot.

Referring to (c) of FIG. 30, when the controller 180 receives an input of touching a predetermined slot and then dragging the predetermined slot to a deletion icon 61, the controller 180 may be configured to delete the video of the predetermined slot. For example, when the controller 180 receives an input of touching the video 65-1 of the user “Kim” assigned to the fourth slot and then dragging the video 65-1 to the deletion icon 61, the controller 180 may delete the video 65-1 of the user “Kim”.

Referring to (d) of FIG. 30, when a storage icon 63 is selected, the controller 180 may be configured to store the first video V1 and the received videos as one video.

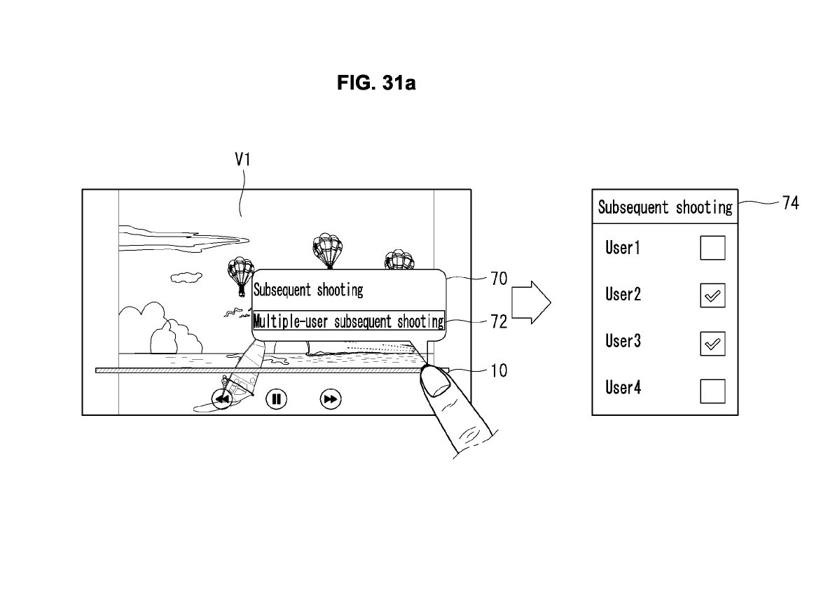

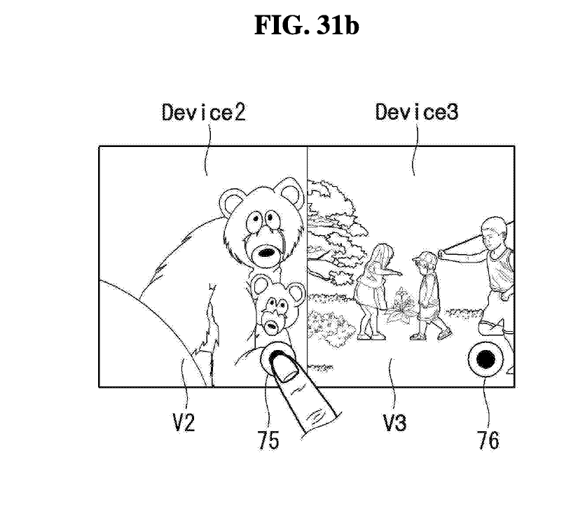

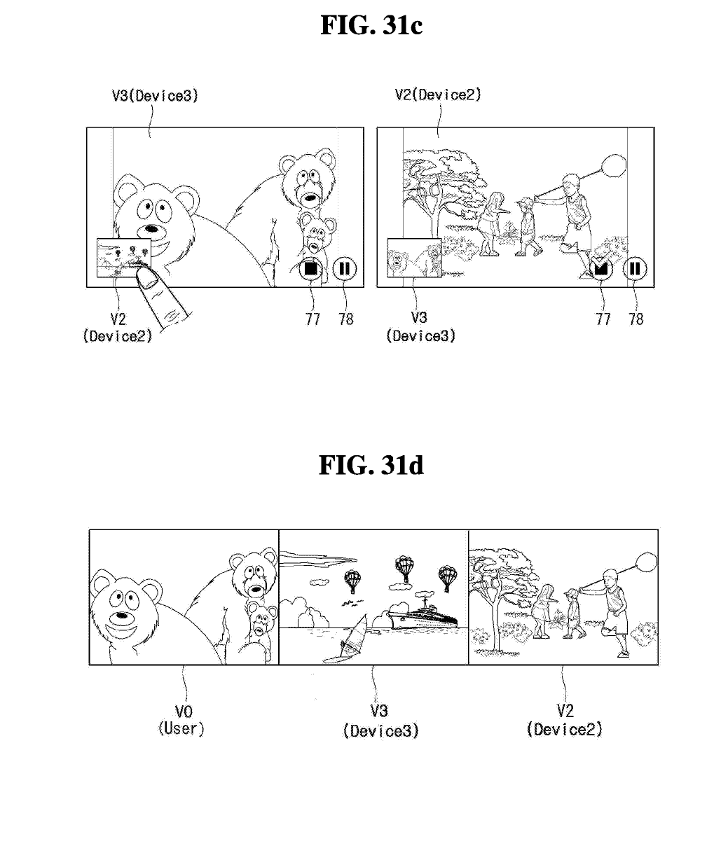

FIG. 31 illustrates an example of a method for receiving videos taken in real time after requesting other user to take a video, and storing the receiving videos as one video.

Referring to FIG. 31a, the controller 180 may be configured to display a video V0 of the user on the touch screen 151 and display the progress bar 10 for controlling the video V0 of the user.

When the controller 180 receives a predetermined input with respect to the progress bar 10, the controller 180 may be configured to display a subsequent shooting menu 70 for taking a video subsequent to a point selected from the video V0 of the user being played. For example, when the controller 180 receives a long touch input with respect to the progress bar 10, the controller 180 may be configured to display the subsequent shooting menu 70 for taking a video subsequent to a time point of the video V0 of the user corresponding to a time line of a touch input.

The subsequent shooting menu 70 may include a subsequent shooting menu for inserting videos taken by the user in real time and a multiple-user subsequent shooting menu 72 for inserting videos taken with a plurality of devices by a plurality of users in real time.

When the controller 180 receives a selection signal of the multiple-user subsequent shooting menu 72, the controller 180 may be configured to display a setting screen 74 for requesting other devices a video on the touch screen 151.

The setting screen 74 may include a list of other devices connected to each other through a network, such as Bluetooth and Wifi, or directly connected to each other, so as to receive videos being taken with the other devices in real time. In the embodiment disclosed herein, the other devices are devices capable of transmitting a video being taken with a camera in real time and may include a digital camera connectable through a network, a net cam as well as a mobile terminal.

The controller 180 may be configured to receive a selection of devices (for example, Device2 and Device3), which the user wants to select among devices capable of receiving a video being taken in real time. Hence, the controller 180 may be configured to request the devices Device2 and Device3 selected by the user to take a video and transmit the video.

Referring to FIG. 31b, the controller 180 may be configured to receive a video being taken from the devices Device2 and Device3 selected by the user in real time and display the received video on the touch screen 151.

The controller 180 may be configured to receive a second device video V2 being taken with the device Device2 and a third device video V3 being taken with the device Device3 in real time and simultaneously display the two videos V2 and V3 on the touch screen 151. In this instance, the controller 180 may be configured to display device selection buttons 75 and 76 for selecting one of the second device video V2 being taken with the device Device2 and the third device video V3 being taken with the device Device3.

Hence, the user may select one (subsequent to the video V0 of the user) of the two videos V2 and V3 displayed on the touch screen 151 and select the device taking the selected video.

The controller 180 may be configured to provide the device video of the device selection button receiving a selection signal among the device selection button 75 displayed on the second device video V2 and the device selection button 76 displayed on the third device video V3, as a preview image.

FIG. 31c illustrates an example of displaying the third device video V3 as a preview image when the device selection button 76 displayed on the third device video V3 is selected, and then displaying the second device video V2 as a preview image depending on a user input.

When the device selection button 76 displayed on the third device video V3 is selected, the controller 180 may be configured to display the third device video V3 being taken with the device Device3 as a preview image. The controller 180 may be configured to display a recording button 77 and a recording stop button 78 for recording and stopping the preview image V3 on a predetermined area of the preview image V3.

When the controller 180 receives a selection input of the recording button 77 in a state where the third device video V3 being taken with the device Device3 is displayed as the preview image, the controller 180 may be configured to record the third device video V3.

The controller 180 may be configured to display the second device video V2 as the preview image on a predetermined area of the screen while recording the third device video V3. When the controller 180 receives a predetermined input with respect to the second device video V2, the controller 180 may be configured to display the second device video V2 being taken with the device Device2 on the entire screen and record the second device video V2.

When the controller 180 receives a selection input of the recording stop button 78, the controller 180 may be configured to insert the third device video V3 and the second device video V2, which are recorded so far, into the video V0 of the user and store them as one video.

Referring to FIG. 31d, the controller 180 may be configured to sequentially insert the third device video V3, which is received from the device Device3 and recorded, and the second device video V2, which is received from the device Device2 and recorded, subsequently to a time point selected from the progress bar 10 of the user video V0 and store them as one video.

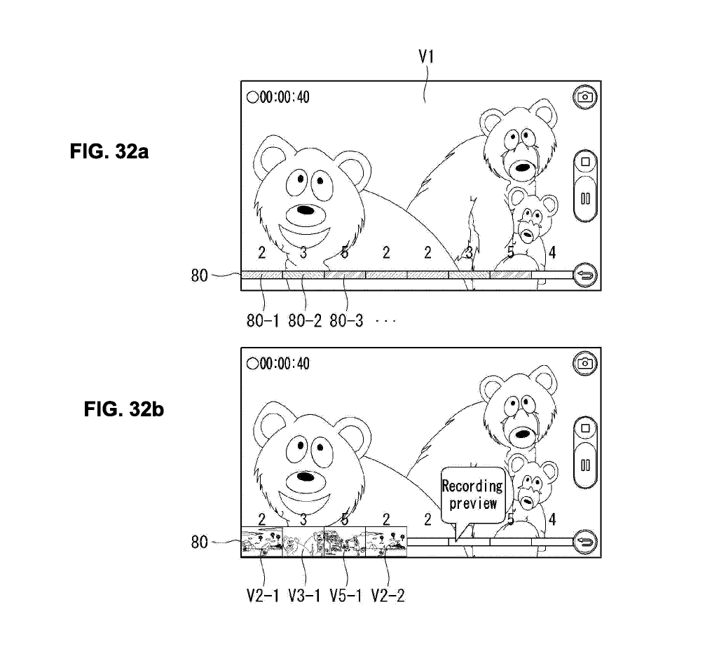

FIG. 32 illustrates an example of dividing an entire video into a plurality of sections before taking a video, previously determining a theme of each section, inserting individually taken videos into corresponding sections, and store them as one video.

Referring to (a) of FIG. 32, the controller 180 may be configured to divide a progress bar 80 displaying a time line of an entire video, which will be produced, into a plurality of sections 80-1, 80-2, 80-3, . . . , depending on user setting and previously determine a theme of each section.

For example, the controller 180 may be configured to display the sections having the same theme as the same number or the same color. In the embodiment disclosed herein, the user may arbitrarily set a setting time of the progress bar 80, time assigned to each section, arrangement order of the sections, etc. For example, the controller 180 may be configured to previously receive a storage position of a section in which people is recorded, a storage position of a section in which animal is recorded, and a storage position of a section in which background is recorded, from the user. The controller 180 may be configured to produce the progress bar 80 divided into the plurality of sections 80-1, 80-2, 80-3, . . . , depending on the user setting.

The controller 180 may be configured to display a video V1 taken with the camera on the touch screen 151 and insert the taken video V1 into the corresponding section when the shooting ends.

Referring to (b) of FIG. 32, the controller 180 may be configured to insert a video, which has been already taken, into the corresponding section in the progress bar 80 divided into the plurality of sections 80-1, 80-2, 80-3, . . . , and display preview images V2-1, V3-1, V5-1, and V2-2 of the inserted video.

In the embodiment disclosed herein, videos may be classified depending on previously determined themes and may be inserted into the section related to the corresponding theme. For example, videos V2-1 and V2-2 corresponding to theme 2 may be inserted into a position of the progress bar 80 assigned as a section of the theme 2; a video V3-1 corresponding to theme 3 may be inserted into a position of the progress bar 80 assigned as a section of the theme 3; and a video V5-1 corresponding to theme 5 may be inserted into a position of the progress bar 80 assigned as a section of the theme 5.

The controller 180 may be configured to insert the videos into all of the sections of the progress bar 80 and store them as one video.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

A mobile terminal may include a first touch screen configured to display a first object, a second touch screen configured to display a second object, and a controller configured to receive a first touch input applied to the first object and to link the first object to a function corresponding to the second object when receiving a second touch input applied to the second object while the first touch input is maintained.

A method may be provided of controlling a mobile terminal that includes displaying a first object on the first touch screen, displaying a second object on the second touch screen, receiving a first touch input applied to the first object, and linking the first object to a function corresponding to the second object when a second touch input applied to the second object is received while the first touch input is maintained.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal comprising:
a touch screen; and
a controller configured to display a first video and a progress bar for controlling a playback of the first video on the touch screen, and when receiving a drag input of a touch input subsequent to the touch input of the progress bar, configured to display a screen for inserting a second video subsequent to a time point of the first video corresponding to a time line of the touch input.

2. The mobile terminal of claim 1, further comprising a camera configured to produce the second video,
wherein the controller is configured to activate the camera when receiving the drag input and display a preview image of the camera on at least one area of a screen for the playback of the first video.

3. The mobile terminal of claim 1, wherein when the drag input is performed at an angle equal to or greater than a predetermined angle with respect to a travelling direction of the progress bar, the controller is configured to display the screen for inserting the second video.

4. The mobile terminal of claim 1, wherein when the controller receives the touch input with respect to the progress bar, the controller is configured to display a preview image of the first video corresponding to the time line of the touch input, and
wherein when the touch input is dragged in a display direction of the preview image, the controller is configured to display information for inserting the second video.

5. The mobile terminal of claim 1, wherein the controller is configured to display a menu for selecting a method for editing the first video and the second video depending on a distance of the drag input.

6. The mobile terminal of claim 5, wherein when it is determined that the distance of the drag input is equal to or greater than a first reference distance and is less than a second reference distance, the controller is configured to display a menu for selecting a method for editing including inserting or overwriting the second video into or on the first video.

7. The mobile terminal of claim 5, wherein when it is determined that the distance of the drag input is equal to or greater than a second reference distance and is less than a third reference distance, the controller is configured to display a menu for selecting a frame division method for displaying the first video and the second video on one screen.

8. The mobile terminal of claim 5, wherein when it is determined that the distance of the drag input is equal to or greater than a third reference distance, the controller is configured to display a menu for selecting a frame division method for displaying a plurality of videos including the first video and the second video on one screen.

9. The mobile terminal of claim 1, wherein the controller is configured to display the second video on at least one area of the first video, and
wherein when the controller receives a predetermined input, the controller is configured to control an aspect ratio of each of the first video and the second video.

10. The mobile terminal of claim 1, wherein the controller is configured to display the second video on at least one area of the first video, and
wherein when the controller receives a predetermined input, the controller is configured to change a display position of the second video displayed on the first video.

11. The mobile terminal of claim 1, wherein the controller is configured to insert and store the second video subsequent to the time point of the first video corresponding to the time line of the touch input and display the progress bar so that a time line of the progress bar, at which the second video is inserted, is distinguished from a time line of the first video.

12. The mobile terminal of claim 1, wherein the controller is configured to insert and store the second video subsequent to the time point of the first video corresponding to the time line of the touch input and display a preview image of the second video at a point of the progress bar, at which the second video is inserted.

13. The mobile terminal of claim 1, wherein the controller is configured to display a preview image of the second video on at least one area of a screen for the playback of the first video, and
wherein when the controller receives a touch input with respect to the preview image of the second video, the controller is configured to display the second video on an entire screen of the touch screen.

14. The mobile terminal of claim 13, wherein the controller is configured to display a menu for selecting an end of the second video on at least one area of the second video, and
wherein when the menu for selecting the end of the second video is selected, the controller is configured to insert the second video into the first video and store the second video.

15. A method for controlling a mobile terminal comprising:
displaying a first video and a progress bar for controlling a playback of the first video on a touch screen;
receiving a touch input with respect to the progress bar; and
when receiving a drag input of the touch input subsequent to the touch input, displaying a screen for inserting a second video subsequent to a time point of the first video corresponding to a time line of the touch input.

16. The method of claim 15, further comprising:
activating a camera configured to produce the second video when receiving the drag input; and
displaying a preview image of the camera on at least one area of a screen for the playback of the first video.

17. The method of claim 15, wherein the displaying of the screen for inserting the second video subsequent to the time point of the first video corresponding to the time line of the touch input when receiving the drag input of the touch input subsequent to the touch input comprises displaying the screen for inserting the second video when the drag input is performed at an angle equal to or greater than a predetermined angle with respect to a travelling direction of the progress bar.

18. The method of claim 15, further comprising:
when receiving the touch input with respect to the progress bar, displaying a preview image of the first video corresponding to the time line of the touch input; and
when dragging the touch input in a display direction of the preview image, displaying information for inserting the second video.

19. The method of claim 15, further comprising displaying a menu for selecting a method for editing the first video and the second video depending on a distance of the drag input.

20. The method of claim 15, further comprising:
displaying the second video on at least one area of the first video; and
when receiving a predetermined input, controlling an aspect ratio of each of the first video and the second video or changing a display position of the second video.
